(19) United States
(12) Patent Application Publication
(10) Pub. No.: US 2025/0012365 A1
(43) Pub. Date: Jan. 9, 2025

(54) FLUIDIC DEVICES AND RELATED METHODS

(71) Applicant: Facebook Technologies, LLC, Menlo Park, CA (US)

(72) Inventors: Riccardo DeSalvo, Pasadena, CA (US); Nicole Kathleen Virdone, Pasadena, CA (US); Sabrina Monique Sandoval, Redondo Beach, CA (US)

(21) Appl. No.: 17/841,647

(22) Filed: Jun. 15, 2022

Related U.S. Application Data
(60) Provisional application No. 63/214,604, filed on Jun. 24, 2021.

(51) Int. Cl. F16K 11/085; F16K 27/06; F16K 31/122

(52) U.S. Cl. CPC F16K 11/085; F16K 27/065; F16K 31/1225

(57) ABSTRACT

Fluidic devices may include a valve body including an upper valve housing and a lower valve housing secured to each other, a cylinder positioned between the upper valve housing and the lower valve housing, and a piston positioned within a valve chamber within the cylinder. Various other methods, systems, and devices are also disclosed.

### CROSS REFERENCE TO RELATED APPLICATION

This application claims the benefit of U.S. Provisional Application No. 63/214,604, filed 24 Jun. 2021, the disclosure of which is incorporated, in its entirety, by this reference.

### BRIEF DESCRIPTION OF THE DRAWINGS

The accompanying drawings illustrate a number of example embodiments and are a part of the specification. Together with the following description, these drawings demonstrate and explain various principles of the present disclosure.

FIG. 1 is an illustration of an example fluidic control system that may be used in connection with embodiments of this disclosure.

FIGS. 2A and 2B are cross-sectional side views of a fluidic device that may be used as a fluidic switch or a fluidic oscillator, according to at least one embodiment of the present disclosure.

FIGS. 3A and 3B are cross-sectional side views of a fluidic device, according to at least one additional embodiment of the present disclosure.

FIG. 4 is a side view of a fluidic device that may be used as a fluidic switch or a fluidic oscillator, according to at least one embodiment of the present disclosure.

FIGS. 5A-5C illustrate various perspective views of a fluidic device, according to at least one further embodiment of the present disclosure. FIG. 5A is an exploded perspective view, FIG. 5B is an assembled perspective view, and FIG. 5C is a partially transparent perspective view of the fluidic device.

FIGS. 6A and 6B illustrate two views of a fluidic device, according to at least one other embodiment of the present disclosure. FIG. 6A is a perspective view and FIG. 6B is a plan view of the fluidic device.

FIG. 7 is a cross-sectional side view of a fluidic device, according to at least one additional embodiment of the present disclosure.

FIGS. 8A and 8B respectively illustrate a top view and a partially transparent, cross-sectional side view of a fluidic device, according to at least one additional embodiment of the present disclosure.

FIGS. 9A-9C illustrate various views of a cylinder blank that may be used in the mass production of fluidic devices, according to at least one embodiment of the present disclosure. FIG. 9A is a perspective view, FIG. 9B is a front side view, and FIG. 9C is a back side view of the cylinder blank.

FIG. 10 shows a perspective view of a valve housing blank that may be used in the mass production of fluidic devices, according to at least one embodiment of the present disclosure.

FIG. 11 shows a perspective view of the cylinder blank of FIGS. 9A-9C assembled with the housing blank of FIG. 10 during a mass production process of fluidic devices, according to at least one embodiment of the present disclosure.

FIG. 12 shows a plan view of a valve housing blank that may be used in the mass production of fluidic devices, according to at least one additional embodiment of the present disclosure.

FIG. 13 is a flow chart showing a method of forming fluidic devices, according to at least one embodiment of the present disclosure.

FIG. 14 is a flow chart showing a method of forming fluidic devices, according to at least one additional embodiment of the present disclosure.

FIG. 15 is an illustration of example augmented-reality glasses that may be used in connection with embodiments of this disclosure.

FIG. 16 is an illustration of an example virtual-reality headset that may be used in connection with embodiments of this disclosure.

FIG. 17 is an illustration of example haptic devices that may be used in connection with embodiments of this disclosure.

FIG. 18 is an illustration of an example virtual-reality environment according to embodiments of this disclosure.

FIG. 19 is an illustration of an example augmented-reality environment according to embodiments of this disclosure.

Throughout the drawings, identical reference characters and descriptions indicate similar, but not necessarily identical, elements. While the example embodiments described herein are susceptible to various modifications and alternative forms, specific embodiments have been shown by way of example in the drawings and will be described in detail herein. However, the example embodiments described herein are not intended to be limited to the particular forms disclosed. Rather, the present disclosure covers all modifications, equivalents, and alternatives falling within the scope of the appended claims.

### DETAILED DESCRIPTION OF EXAMPLE EMBODIMENTS

Microfluidic systems are small mechanical systems that involve the flow of fluids. Microfluidic systems can be used in many different fields, such as biomedical, chemical, genetic, biochemical, pharmaceutical, haptics, and other fields. A microfluidic valve is a basic component of a microfluidic system and may be used for stopping, starting, directing, or otherwise controlling flow of a fluid in a microfluidic system. Conventional microfluidic valves may be actuated via fluid pressure, electromagnetically, with a piezoelectric material, or with a spring-loaded mechanism, for example. Microfluidic valves often require a standing current or voltage to maintain a state (e.g., open or closed, right/left direction, etc.).

Haptic feedback mechanisms are designed to provide a physical sensation (e.g., vibration, pressure, heat, etc.) as an indication to a user. For example, vibrotactile devices include devices that may vibrate to provide haptic feedback to a user of a device. For example, some modern mobile devices (e.g., cell phones, tablets, mobile gaming devices, gaming controllers, etc.) include a vibrotactile device that informs the user through a vibration that an action has been taken. The vibration may indicate to the user that a selection has been made or a touch event has been sensed. Vibrotactile devices may also be used to provide an alert or signal to the user. Haptic feedback may be employed in artificial-reality systems (e.g., virtual-reality systems, augmented-reality systems, mixed-reality systems, hybrid-reality systems), such as by providing one or more haptic feedback mechanisms in a controller or a glove or other wearable device.

Various types of vibrotactile devices exist, such as piezoelectric devices, eccentric rotating mass devices, and linear resonant actuators. Such vibrotactile devices may include one or more elements that vibrate upon application of an electrical voltage. In the case of piezoelectric devices, an applied voltage may induce bending or other displacement in a piezoelectric material. Eccentric rotating mass devices induce vibration by rotating an off-center mass around an axle of an electromagnetic motor. Linear resonant actuators may include a mass on an end of a spring that is driven by a linear actuator to cause vibration.

The present disclosure is generally directed to fluidic devices and systems, methods for directing a fluid, and methods of forming fluidic devices and systems. As will be explained in further detail below, embodiments of the present disclosure may include fluidic devices that include a valve chamber in a valve body, a fluid inlet in communication with the valve chamber, a movable piston positioned within the valve chamber, a first fluid outlet for passing fluid out of the valve chamber when the piston is in a first position, and a second fluid outlet for passing fluid out of the valve chamber when the piston is in a second position. In some embodiments, the piston may include a diamagnetic material, a ferromagnetic material, and/or a magnetic material, and the fluidic device may further include at least one magnetic drive mechanism configured to apply a magnetic field to move the piston between the first and second positions. By way of example and not limitation, the systems and devices of the present disclosure may be used in any fluidic application, such as for fluidic haptics, fluidic switching, stiffening or softening of a bladder, filling or exhausting a bladder, applying or releasing pressure, flowing a fluid, stopping flow of a fluid, activating or deactivating a piston, etc.

Features from any of the embodiments described herein may be used in combination with one another in accordance with the general principles described herein. These and other embodiments, features, and advantages will be more fully understood upon reading the following detailed description in conjunction with the accompanying drawings and claims.

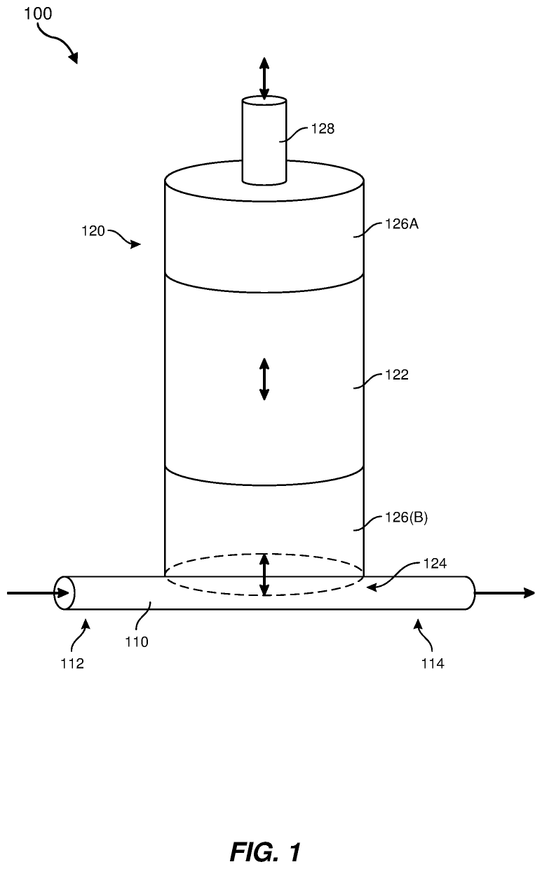

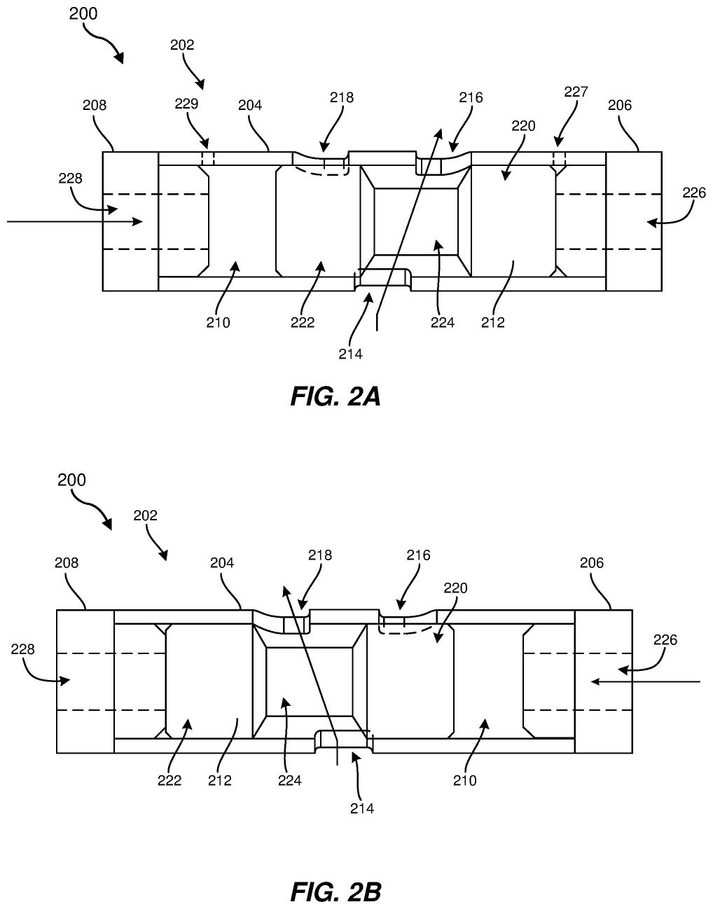

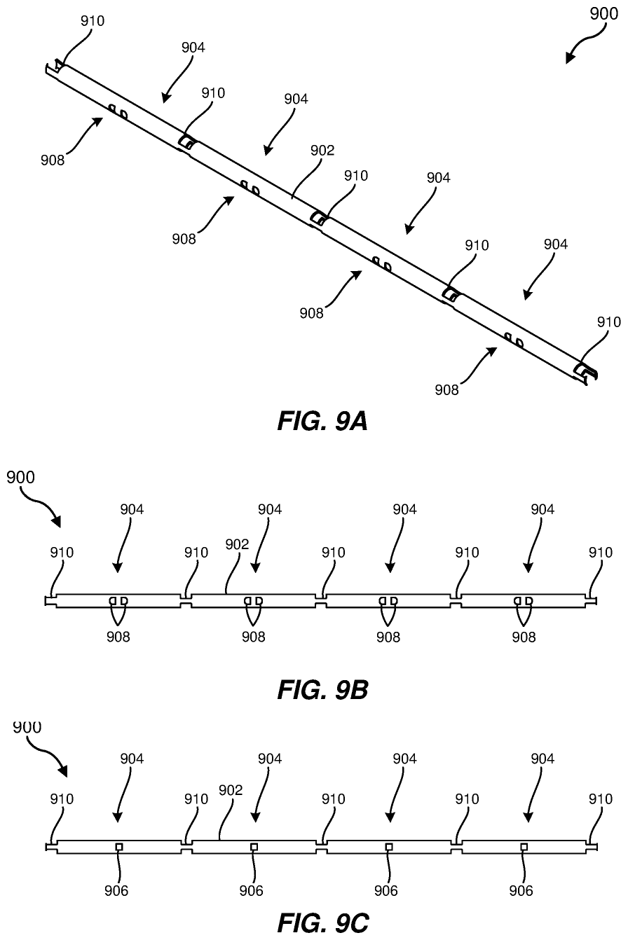

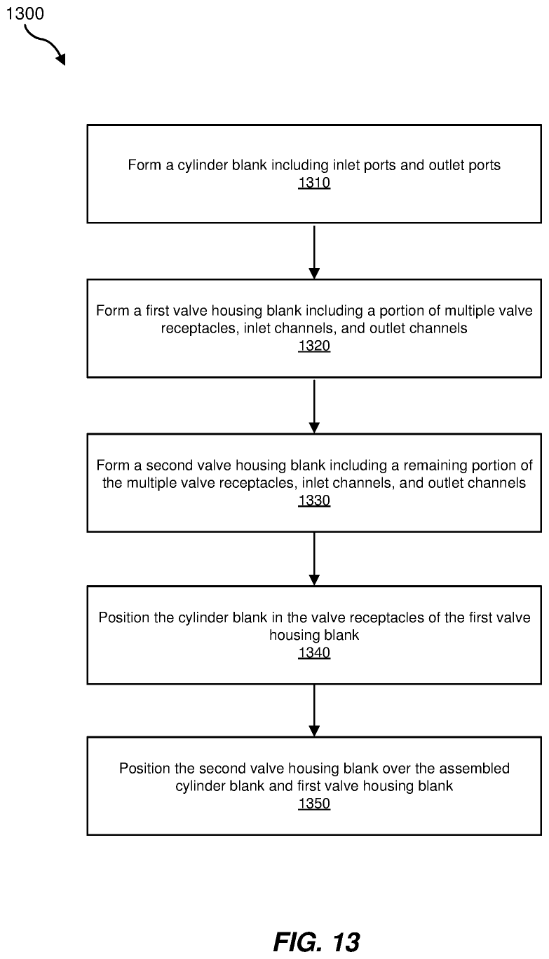

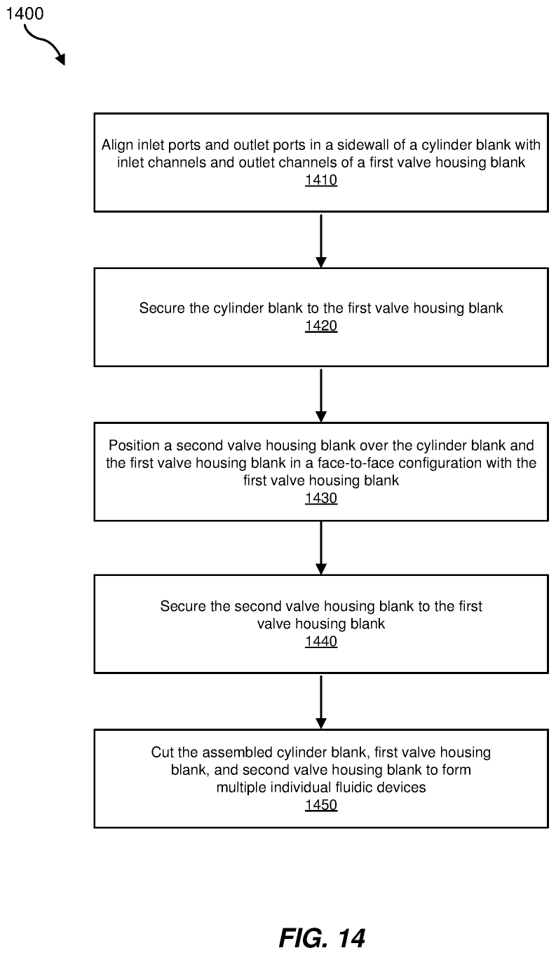

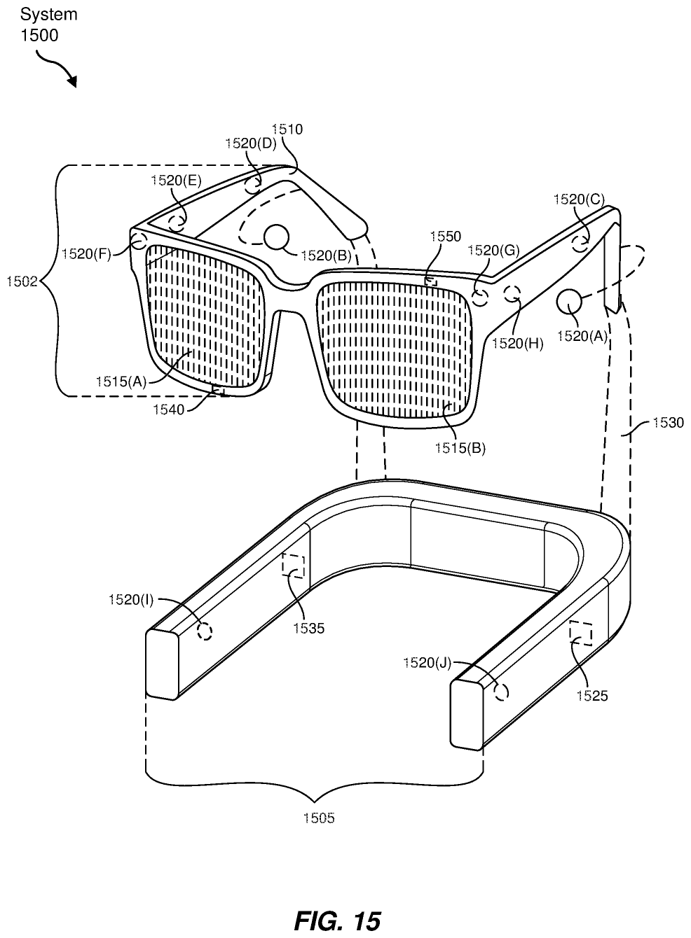

The following will provide, with reference to FIG. 1, detailed descriptions of an example fluidic control system that may be used in connection with embodiments of this disclosure. With reference to FIGS. 2-8, the following will provide detailed descriptions of various example fluidic devices, components thereof, and configurations thereof. The following will also provide descriptions of apparatuses and methods for production of multiple fluidic devices in connection with FIGS. 9-12. With reference to FIGS. 13 and 14, the following will provide detailed descriptions of methods of forming fluidic devices. With reference to FIGS. 15-19, the following will provide detailed descriptions of various devices and systems that may be used in connection with embodiments of this disclosure.

The present disclosure may include fluidic systems (e.g., haptic fluidic systems) that involve the control (e.g., stopping, starting, restricting, increasing, etc.) of fluid flow through a fluid channel. The control of fluid flow may be accomplished with a fluidic valve. FIG. 1 shows a schematic diagram of a fluidic valve 100 for controlling flow through a fluid channel 110, according to at least one embodiment of the present disclosure. Fluid from a fluid source (e.g., a pressurized fluid source, a fluid pump, etc.) may flow through the fluid channel 110 from an inlet port 112 to an outlet port 114, which may be operably coupled to, for example, a fluid-driven mechanism, another fluid channel, or a fluid reservoir.

The fluidic valve 100 may include a gate 120 for controlling the fluid flow through the fluid channel 110. The gate 120 may include a gate transmission element 122, which may be a movable component that is configured to transmit an input force, pressure, or displacement to a restricting region 124 to restrict or stop flow through the fluid channel 110. Conversely, in some examples, application of a force, pressure, or displacement to the gate transmission element 122 may result in opening the restricting region 124 to allow or increase flow through the fluid channel 110. The force, pressure, or displacement applied to the gate transmission element 122 may be referred to as a gate force, gate pressure, or gate displacement. The gate transmission element 122 may be a flexible element (e.g., an elastomeric membrane, a diaphragm, etc.), a rigid element (e.g., a movable piston, a lever, etc.), or a combination thereof (e.g., a movable piston or a lever coupled to an elastomeric membrane or diaphragm).

As illustrated in FIG. 1, the gate 120 of the fluidic valve 100 may include one or more gate terminals, such as an input gate terminal 126(A) and an output gate terminal 126(B) (collectively referred to herein as “gate terminals 126”) on opposing sides of the gate transmission element 122. The gate terminals 126 may be elements for applying a force (e.g., pressure) to the gate transmission element 122. By way of example, the gate terminals 126 may each be or include a fluid chamber adjacent to the gate transmission element 122. Alternatively or additionally, one or more of the gate terminals 126 may include a solid component, such as a lever, screw, or piston, that is configured to apply a force to the gate transmission element 122.

In some examples, a gate port 128 may be in fluid communication with the input gate terminal 126(A) for applying a positive or negative fluid pressure within the input gate terminal 126(A). A control fluid source (e.g., a pressurized fluid source, a fluid pump, etc.) may be in fluid communication with the gate port 128 to selectively pressurize and/or depressurize the input gate terminal 126(A). In additional embodiments, a force or pressure may be applied at the input gate terminal 126(A) in other ways, such as with a piezoelectric element or an electromechanical actuator, etc.

FIGS. 2A and 2B are cross-sectional side views of a fluidic device 200. By way of example and not limitation, the fluidic device 200 may be used as a fluidic oscillator and/or as a fluidic switch. The fluidic device 200 may include a valve body 202 that defines at least in part by a cylinder 204, a first endcap 206, and a second endcap 208. A valve chamber 210 may be defined by an interior of the cylinder 204 and between the endcaps 206, 208. A movable piston 212, which may be movable between a first position (e.g., shown in FIG. 2A) and a second position (e.g., shown in FIG. 2B), may be positioned anywhere within the valve chamber 210.

In some examples, relational terms, such as “first,” “second,” “upper,” “lower,” “inlet,” “outlet,” etc., may be used for clarity and convenience in understanding the disclosure and accompanying drawings and do not connote or depend on any specific preference, orientation, or order, except where the context clearly indicates otherwise. For example, in some examples an inlet port may be used as an outlet port, and an outlet port may be used as an inlet port.

A fluid inlet 214 (e.g., a hole through the cylinder 204) may be in fluid communication with the valve chamber 210. A first fluid outlet 216 and a second fluid outlet 218 (e.g., holes through the cylinder 204) may also be in fluid communication with the valve chamber 210. Depending on the position of the movable piston 212 within the valve chamber 210, the fluidic device 200 may enable the flow of fluid (e.g., a liquid or a gas) into the fluid inlet 214, through the valve chamber 210, and out of the first fluid outlet 216, the second fluid outlet 218, or any ratio of both the first fluid outlet 216 and the second fluid outlet 218.

As illustrated in FIGS. 2A and 2B, the movable piston 212 may, in some examples, have a dumbbell shape, with a first enlarged end portion 220, a second enlarged end portion 222, and a central shaft 224 extending between the enlarged end portions 220, 222. The enlarged end portions 220, 222 may be sized and configured for sliding along an interior surface of the cylinder 204 within the valve chamber 210. The central shaft 224 may, in some examples, be smaller in diameter than the enlarged end portions 220, 222, such that a fluid may be able to flow around the central shaft 224 to one or both of the fluid outlets 216, 218, depending on the position of the movable piston 212. In additional embodiments, rather than or in addition to including the central shaft 224, one or more channels may extend through the movable piston 212 to provide a fluid pathway between the fluid inlet 214 and the fluid outlet(s) 216, 218.

The first endcap 206 may include a first piston actuation inlet 226, which may be a hole passing through the first endcap 206. Likewise, the second endcap 208 may include a second piston actuation inlet 228, which may be a hole passing through the second endcap 208. When a fluid pressure is applied to the movable piston 212 through the first piston actuation inlet 226, the movable piston 212 may move from the first position (shown in FIG. 2A) to the second position (shown in FIG. 2B). Similarly, when a fluid pressure is applied to the movable piston 212 through the second piston actuation inlet 228, the movable piston 212 may move from the second position to the first position.

The fluidic device 200 has been described as including the first piston actuation inlet 226 and the second piston actuation inlet 228 respectively passing through the first endcap 206 and the second endcap 208. However, embodiments of the present disclosure are not so limited. For example, in additional embodiments, a first piston actuation inlet 227 and a second piston actuation inlet 229 may be or include holes passing through a sidewall of the cylinder 204, as illustrated in FIG. 2A in dashed lines.

When the movable piston 212 is in the first position (FIG. 2A), fluid may be able to flow from the fluid inlet 214 to the first fluid outlet 216, and the second fluid outlet 218 may be blocked by the movable piston 212 (e.g., by the second enlarged end portion 222). When the movable piston 212 is in the second position (FIG. 2B), fluid may be able to flow from the fluid inlet 214 to the second fluid outlet 218, and the first fluid outlet 216 may be blocked by the movable piston 212 (e.g., by the first enlarged end portion 220). If there is no pressure differential between the first piston actuation inlet 226 and the second piston actuation inlet 228, the movable piston 212 may remain in its position (e.g., the first position, the second position, or any intermediate position between the first and second positions). For example, the fluid flowing from the fluid inlet 214 to the first fluid outlet 216 or to the second fluid outlet 218 may act on the movable piston 212 in substantially equal and opposite (e.g., in the left and right directions of FIGS. 2A and 2B) magnitudes. Accordingly, in the absence of an applied pressure through the first piston actuation inlet 226 and/or the second piston actuation inlet 228, the movable piston 212 may remain in a fixed position within the valve chamber 210. Thus, in some embodiments, the fluidic device 200 may be configured and operated as a fluidic switch that may require no standing power (e.g., pressure, electrical power, etc.) to remain in a desired state (e.g., inducing flow to the first fluid outlet 216, to the second fluid outlet 218, or split between the first and second fluid outlets 216, 218).

Although the fluidic device 200 is scalable for different applications, in some embodiments, an internal diameter of the fluid inlet 214 may be about 2 mm or less (e.g., 2 mm, 1 mm, 0.5 mm, etc.). For example, the fluidic device 200 may be sufficiently small for incorporation in a fluidic system of a haptic device, such as a haptic glove. In addition, forming the fluidic device 200 to have a fluid inlet 214 with an internal diameter of about 2 mm or less (e.g., 2 mm, 1 mm, 0.5 mm, etc.) may reduce a power input required to flow fluid through the fluidic device 200, compared to larger internal diameters.

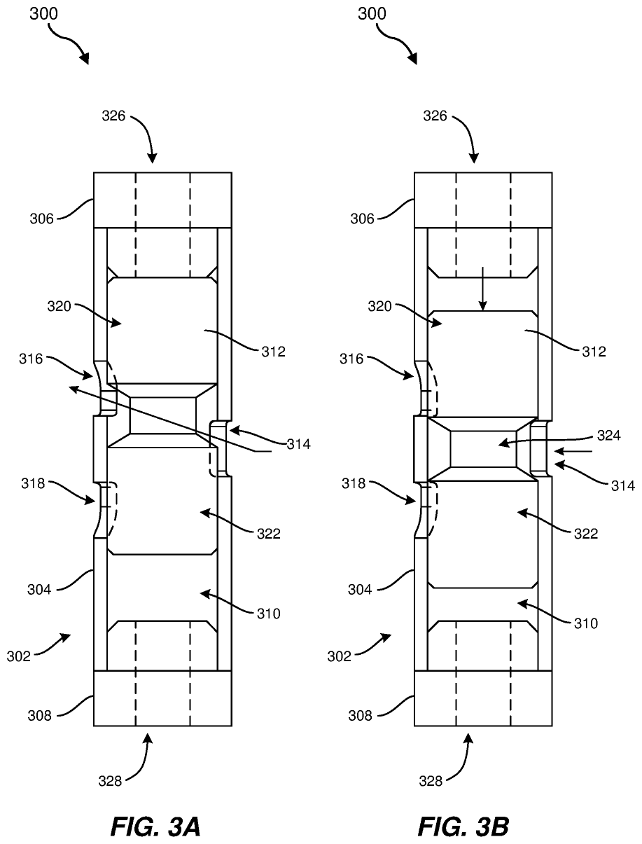

FIGS. 3A and 3B are side cross-sectional views of a fluidic device 300 according to additional embodiments of the present disclosure. The fluidic device 300 may be similar to the fluidic device 200 described above with reference to FIGS. 2A and 2B. For example, the fluidic device 300 may include a valve body 302, which may include a cylinder 304, a first endcap 306, and a second endcap 308. A valve chamber 310 may be defined inside the valve body 302. A movable piston 312 may be movably positioned within the valve chamber 310. The valve chamber 310 may be in fluid communication with a fluid inlet 314, a first fluid outlet 316, a second fluid outlet 318, a first piston actuation inlet 326, and a second piston actuation inlet 328.

The movable piston 312 may, in some examples, have a dumbbell shape, with a first enlarged end portion 320, a second enlarged end portion 322, and a central shaft 324 extending between the enlarged end portions 320, 322. The enlarged end portions 320, 322 may be sized and configured for sliding along an interior surface of the cylinder 304 within the valve chamber 310. The central shaft 324 may, in some examples, be smaller in diameter than the enlarged end portions 320, 322, such that a fluid may be able to flow around the central shaft 324 to one of the fluid outlets 316, 318, depending on the position of the movable piston 312. In this example, the central shaft 324 may be shortened such that flow from the fluid inlet 314 may be blocked from flowing to either of the fluid outlets 316, 318 when the movable piston 312 is in at least one intermediate position between a first position in which fluid may flow to the first fluid outlet 316 and a second position in which fluid may flow to the second fluid outlet 318.

For example, FIG. 3A illustrates the movable piston 312 in the first position in which fluid may be able to flow from the fluid inlet 314 to the first fluid outlet 316, similar to FIG. 2A above. On the other hand, FIG. 3B illustrates the movable piston 312 in an intermediate position in which fluid is blocked from flowing from the fluid inlet 314 to either of the first fluid outlet 316 or the second fluid outlet 318. In this intermediate position, the first enlarged end portion 320 of the movable piston 312 may block the first fluid outlet 316 and the second enlarged end portion 322 may block the second fluid outlet 318. Since fluid entering the valve chamber 310 through the fluid inlet 314 has no available outlet, the fluidic device 300 may stop fluid flow when the movable piston 312 is in this intermediate position shown in FIG. 3B. In some examples, the movable piston 312 may be able to remain in the intermediate position to stop fluid flow through the fluidic device 300 with no required standing power (e.g., pressure).

The fluidic device 300 of FIGS. 3A and 3B has been described as including a movable piston 312 with a shortened central shaft 324 (e.g., compared to the central shaft 224 of the fluidic device 200 described with reference to FIGS. 2A and 2B). However, the present disclosure is not so limited. Alternatively or additionally, the first and second fluid outlets 316, 318 may be positioned farther from each other (e.g., compared to the embodiment shown in FIGS. 2A and 2B) to provide a greater portion of the cylinder 304 between the fluid outlets 316, 318. In this example, the central shaft 324 may, in some embodiments, not be shortened relative to the embodiment shown in FIGS. 2A and 2B and the resulting movable piston 312 may still have an intermediate position in which the fluid flow is stopped, as described above with reference to FIG. 3B. In further examples, one or both of the fluid outlets 316, 318 may have a different shape and/or size, such as to induce a different pressure or flow profile when the fluidic device 300 is in operation.

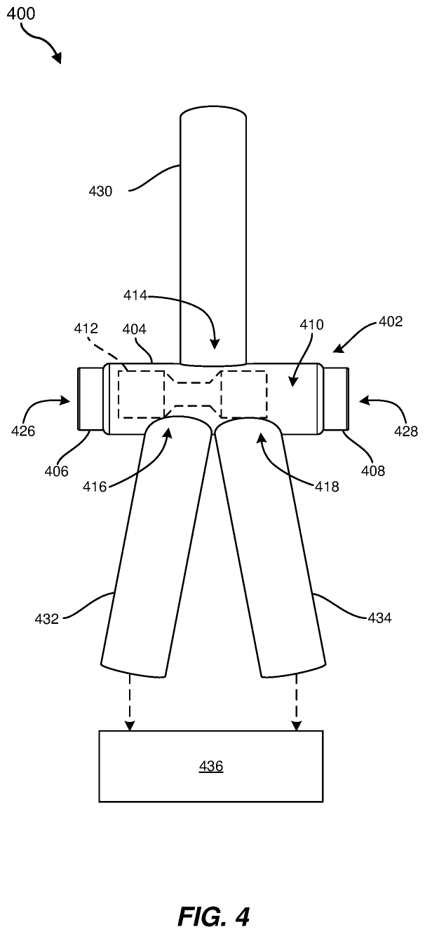

FIG. 4 is a side view of a fluidic device 400. The fluidic device 400 may be similar to the fluidic device 200 or 300 described above with reference to FIGS. 2A and 2B or FIGS. 3A and 3B. For example, the fluidic device 400 may include a valve body 402, which may include a cylinder 404, a first endcap 406, and a second endcap 408. A valve chamber 410 may be defined inside the valve body 402. A movable piston 412 may be movably positioned within the valve chamber 410. The valve chamber 410 may be in fluid communication with a fluid inlet 414, a first fluid outlet 416, a second fluid outlet 418, a first piston actuation inlet 426, and a second piston actuation inlet 428.

As shown in FIG. 4, an inlet extension 430 may be operably coupled to the fluid inlet 414, a first outlet extension 432 may be operably coupled to the first fluid outlet 416, and a second outlet extension 434 may be operably coupled to the second fluid outlet 418. The extensions 430, 432, 434 may, for example, be brazed, welded, adhered, interference-fit, press-fit, snap-fit, screwed, or otherwise coupled to the respective inlet 414 or outlet 416, 418. The extensions 430, 432, 434 may be included, shaped, sized, and configured to facilitate coupling conduits (e.g., flexible conduits, piping, fluid channels, etc.) to the fluidic device 400. The piston actuation inlets 426, 428 may also be shaped, sized, and configured to facilitate coupling other conduits to the fluidic device for applying a pressure to move the movable piston 412 within the valve chamber 410. A fluid-driven device 436 may be fluidically coupled to one or both of the outlets 416, 418, such as via the extensions 432, 434 and/or additional conduit. By way of example and not limitation, the fluid-driven device 436 may include a haptic feedback device, a piston device, an inflatable bladder, a fan or other rotatable element, etc.

Embodiments of the present disclosure have been described above as including a single fluid inlet 214, 314, 414 and two respective fluid outlets 216, 218, 316, 318, 416, 418. However, the present disclosure is not so limited. For example, an operation and orientation of the fluidic devices 200, 300, 400 may be flipped compared to these described embodiments. For example, the fluid inlets 214, 314, 414 may function as fluid outlets and the fluid outlets 216, 218, 316, 318, 416, 418 may function as fluid inlets. Thus, in some examples, fluid from two respective inlets may be selectively passed to a single fluid outlet depending on a position of the piston 212, 312, 412. By way of example and not limitation, two fluid sources may supply fluid having one or more different properties (e.g., temperature, pressure, fluid type, flow rate, etc.) to the fluidic devices 200, 300, 400 for selection by the fluidic devices 200, 300, 400.

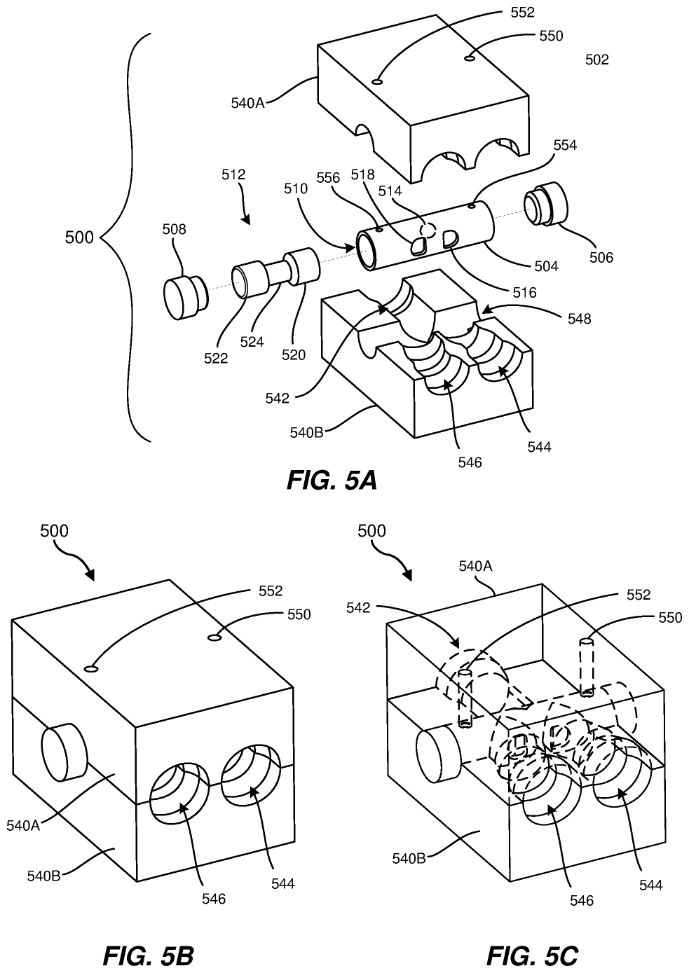

FIGS. 5A-5C illustrate various perspective views of a fluidic device 500, according to at least one further embodiment of the present disclosure. FIG. 5A is an exploded perspective view, FIG. 5B is an assembled perspective view, and FIG. 5C is a partially transparent perspective view of the fluidic device 500.

The fluidic device 500 may include some similar features and elements to the fluidic devices 200, 300, 400 described above. For example, the fluidic device 500 may include a valve body 502 including a cylinder 504, a first endcap 506, and a second endcap 508. A valve chamber 510 may be defined within the cylinder 504 and between the endcaps 506, 508. A movable piston 512 may be positioned within the valve chamber 510. Several ports may provide fluid access to the valve chamber 510, such as a fluid inlet 514, a first fluid outlet 516, and a second fluid outlet 518.

The piston 512 may include a first enlarged end portion 520 and a second enlarged end portion 522 opposite the first enlarged end portion 520. A central shaft 524, which may have a smaller outer diameter than the enlarged end portions 520, 522, may extend between the enlarged end portions 520, 522.

As illustrated in FIGS. 5A-5C, the valve body 502 may also include an upper valve housing 540A and a lower valve housing 540B (collectively referred to as a valve housing 540). The valve housing 540 may secure the cylinder 504 in place and may include features for coupling inlet lines and outlet lines (e.g., pipes, tubes, etc.) to the fluidic device 500. For example, the valve housing 540 may include an inlet channel 542, a first outlet channel 544, and a second outlet channel 546 positioned for respectively providing fluid access to the fluid inlet 514, the first fluid outlet 516, and the second fluid outlet 518. The valve housing 540 may also include a valve receptacle 548 shaped and sized for receiving and holding the cylinder 504.

The upper valve housing 540A and the lower valve housing 540B may be capable of assembling to each other around the cylinder 504 to form the fluidic device 500. In some embodiments, the upper valve housing 540A and the lower valve housing 540A may be substantially identical to each other, such as having the same form, shape, and configuration. Thus, in some embodiments, the upper valve housing 540A and the lower valve housing 540B may be interchangeable with each other to facilitate assembly. In additional embodiments, the upper valve housing 540A and the lower valve housing 540B may be different, such as by having a different arrangement of pilot holes 550, 552, lacking pilot holes 550 and 552, having other elements in a different position, lacking certain features, etc. The upper valve housing 540A and the lower valve housing 540B may be secured to each other with an adhesive, a weld, and/or with a fastener (e.g., a clip, a screw, a pin, etc.).

In some examples, the term “substantially” in reference to a given parameter, property, or condition, may refer to a degree that one skilled in the art would understand that the given parameter, property, or condition is met with a small degree of variance, such as within acceptable manufacturing tolerances. For example, a parameter that is substantially met may be at least about 90% met, at least about 95% met, at least about 99% met, or fully met.

As shown in FIGS. 5A-5C, at least the upper valve housing 540A may include a first piston actuation inlet 550 and a second piston actuation inlet 552 for fluidically (e.g., pneumatically) controlling the position of the piston 512 within the cylinder 504. The cylinder 504 may also include corresponding sidewall holes 554, 556 to provide fluid access to the valve chamber 510 within the cylinder 504 through the first piston actuation inlet 550 and the second piston actuation inlet 552. In this example, the first and second endcaps 506, 508 may be solid, lacking any through hole to the valve chamber 510.

A control fluid (e.g., pressurized air) may be supplied to opposing sides of the piston 512 in the valve chamber 510 through the first and second piston actuation inlets 550, 552. The control fluid may apply pressure to the piston 512 to move the piston 512 between a first position allowing flow between the fluid inlet 514 and the first fluid outlet 516 and a second position allowing flow between the fluid inlet 514 and the second fluid outlet 518. Alternatively or additionally, in some examples, a negative pressure may be applied to the piston 512 through one or both of the first and second piston actuation inlets 550, 552 to move the piston 512 between the first and second positions.

In additional embodiments, a control fluid may be omitted. In such examples, leakage of fluid from the fluid inlet 514 around the piston 512 to a closed side of the piston 512 may build up and force the piston toward the opposing, open side of the piston 512. Leakage around the piston 512 to the open side may escape through the open piston actuation inlet. In some examples, leakage around the piston 512 may be calibrated, such as by providing a leakage orifice or channel through or along the piston 512. A size of the leakage orifice or channel may affect a speed at which the fluidic device 500 can be operated (e.g., a switching time). For example, a larger leakage orifice or channel may enable fluid to pass by the piston faster than a smaller leakage orifice or channel, resulting in faster switching times.

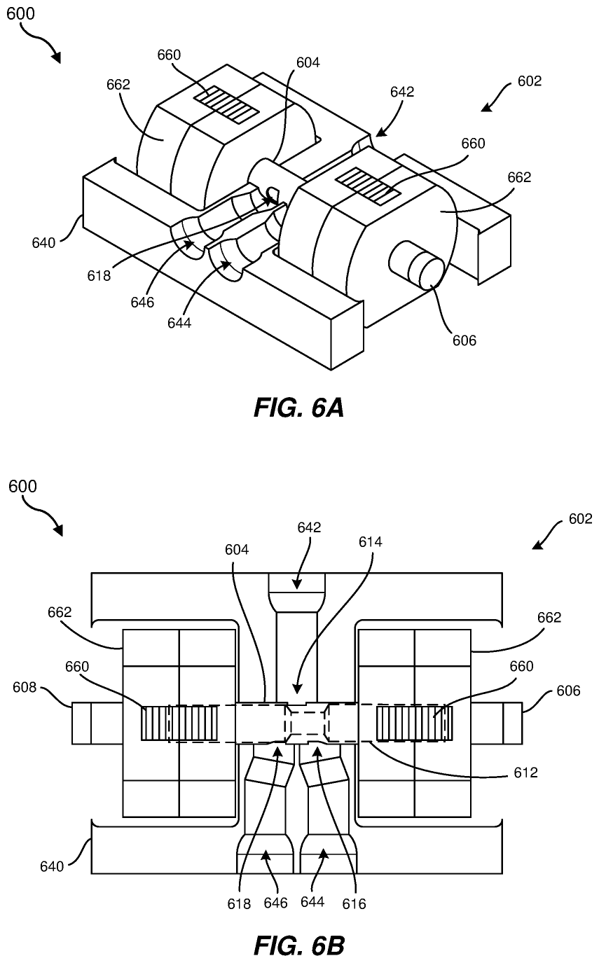

FIGS. 6A and 6B illustrate two views of a fluidic device 600, according to at least one other embodiment of the present disclosure. FIG. 6A is a perspective view and FIG. 6B is a plan view of the fluidic device 600. In FIGS. 6A and 6B, an upper valve housing is removed to better view other components of the fluidic device 600.

In some respects, the fluidic device 600 of FIGS. 6A and 6B may be similar to the fluidic device 500 of FIGS. 5A-5C. For example, the fluidic device 600 may include a valve body 602 including a cylinder 604, a first endcap 606, and a second endcap 608. A valve chamber may be defined within the cylinder 604 and between the endcaps 606, 608. A movable piston 612 may be positioned within the valve chamber. Several ports may provide fluid access to the valve chamber, such as a fluid inlet 614, a first fluid outlet 616, and a second fluid outlet 618.

The valve body 602 may also include an upper valve housing (omitted from FIGS. 6A and 6B for clarity) and a lower valve housing, collectively referred to as a valve housing 640. In some embodiments, the upper valve housing may be substantially identical to the lower valve housing and may be positioned over and secured to the lower valve housing in a face-to-face orientation. The valve housing 640 may include an inlet channel 642, a first outlet channel 644, and a second outlet channel 646 for respectively providing fluid access to the fluid inlet 614, the first fluid outlet 616, and the second fluid outlet 618.

As shown in FIGS. 6A and 6B, the fluidic device 600 may also include one or more conductive coils 660 for driving operation of the fluidic device 600. The piston 612 may include a material (e.g., a diamagnetic material, a ferromagnetic material, a magnetic material, etc.) that is sensitive to a magnetic field induced by the conductive coil(s) 660. In some examples, the conductive coil(s) 660 may be positioned around the cylinder 604 and within one or more corresponding coil housings 662. The piston 612 may be elongated such that end portions thereof may be positioned within or near one or both of the conductive coil(s) 660. When activated (e.g., when a current is applied), the conductive coil(s) 660 may generate a magnetic field that applies a magnetic force to the magnetically sensitive material of the piston 612 to move the piston 612 between a first position allowing flow between the fluid inlet 614 and the first fluid outlet 616 and a second position allowing flow between the fluid inlet 614 and the second fluid outlet 616. Depending on the direction of the magnetic field and the type of material (e.g., diamagnetic, ferromagnetic, and/or magnetic) included in the piston 612, the magnetic force may apply a pushing force and/or a pulling force to the piston 612.

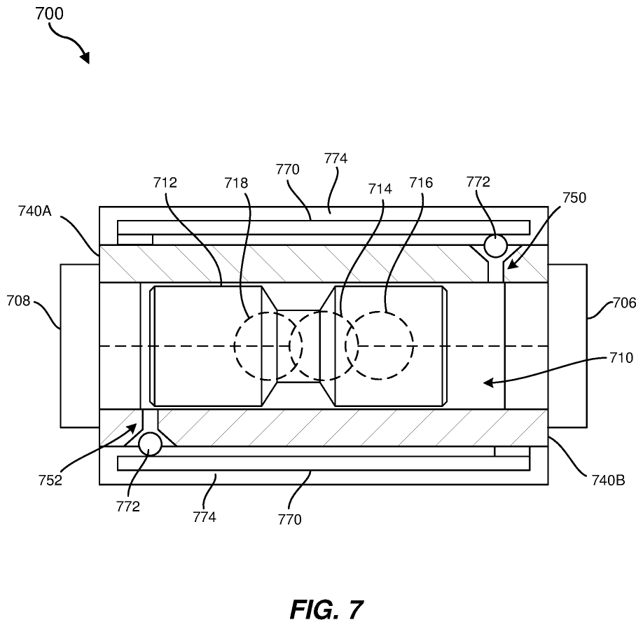

FIG. 7 is a cross-sectional side view of a fluidic device 700, according to at least one additional embodiment of the present disclosure. In some respects, the fluidic device 700 may be similar to the fluidic devices 500, 600 described above. For example, the fluidic device 700 may include a valve body 702, a first endcap 706, and a second endcap 708. A valve chamber 710 may be defined within the valve body 702 and between the endcaps 706, 708. A movable piston 712 may be positioned within the valve chamber 710. Several ports may provide fluid access to the valve chamber 710, such as a fluid inlet 714, a first fluid outlet 716, and a second fluid outlet 718.

The valve body 702 may also include an upper valve housing 740A and a lower valve housing 740B, collectively referred to as a valve housing 740. In some embodiments, the upper valve housing 740A may be substantially identical to the lower valve housing 740B and may be positioned over and secured to the lower valve housing 740B in a face-to-face orientation.

As shown in FIG. 7, the valve housing 740 may include a first piston actuation inlet 750 and a second piston actuation inlet 752 for fluidically (e.g., pneumatically) controlling the position of the piston 712 within the valve chamber 710. A control fluid (e.g., pressurized air) may be supplied from a control fluid source to opposing sides of the piston 712 through the first and second piston actuation inlets 750, 752. The control fluid may apply pressure to the piston 712 to move the piston 712 between a first position allowing flow between the fluid inlet 714 and the first fluid outlet 716 and a second position allowing flow between the fluid inlet 714 and the second fluid outlet 718. Alternatively or additionally, in some examples, a negative pressure may be applied to the piston 712 through one or both of the first and second piston actuation inlets 750, 752 to move the piston 712 between the first and second positions.

In this example shown in FIG. 7, the fluidic device 700 may be electrically controlled, such as with electrosensitive beams 770. Each of the electrosensitive beams 770 may be configured to bend upon actuation by a sufficient electrical control signal. By way of example, the electrosensitive beams 770 may include one or more piezoelectric materials (e.g., a unimorph piezoelectric material, a bimorph piezoelectric material, or a multimorph piezoelectric material). A proximal end of each electrosensitive beam 770 may be secured to the valve housing 740 and a distal end may be free to move, in a cantilevered fashion.

In some embodiments, a drive voltage for operating the electrosensitive beams 770 may be at least partially produced locally on a voltage generator microchip or other haptic driver chip (e.g., with a Cockcroft circuit) mounted near and coupled to the electrosensitive beam 770. This may improve a safety of the fluidic device 700, such as by localizing the voltage (e.g., at or near 100 volts) where the voltage is used.

A valve plug 772 may be secured to a distal end of each electrosensitive beam 770 in a position over the respective first and second piston actuation inlets 750, 752. The electrosensitive beams 770 may be configured to be normally closed or normally open. In the normally closed configuration, the electrosensitive beams 770 may press (e.g., with a spring force) the valve plugs 772 down to close the first and second piston actuation inlets 750, 752 without being actuated. Actuation of the electrosensitive beams 770 may cause the electrosensitive beams 770 to bend away from and open the first and second piston actuation inlets 750, 752, allowing pressurized fluid to flow into (or out of) the valve chamber 710.

In the normally open configuration, the electrosensitive beams 770 may, without being actuated, hold the valve plugs 772 away from the first and second piston actuation inlets 750, 752 to keep the first and second piston actuation inlets 750, 752 open. Upon actuation, the electrosensitive beams 770 may bend toward and close the first and second piston actuation inlets 750, 752 with the valve plugs 772. The electrosensitive beams 770 and the valve plugs 772 may be enclosed in a pressure chamber 774 that may supply pressurized fluid (e.g., pressurized air) to the first and second piston actuation inlets 750, 752 depending on the position of the valve plugs 772.

As noted above with reference to FIG. 5, passage of fluid from the fluid inlet 714 around the piston 712 may be used to drive the piston 712 between the first and second positions. In some examples, a leakage past one or both of the valve plugs 772 may be used to control operation of the fluidic device 700. For example, a calibrated leakage past one of the valve plugs 772 may be provided, allowing an appropriate amount of fluid to pass around and/or through the leaking valve plug 772. When the other valve plug 772 is opened, fluid from the inlet leaking past the piston may build up on side of the piston 712 proximate the leaking valve plug 772 (since fluid leaking to the open side escapes through the open piston actuation inlet 750, 752 and there is no pressure buildup there), causing the piston 712 to move. When the open valve plug 772 is closed, fluid with higher pressure from the fluid inlet 714 leaking past the piston 712 may build up on the closed side of the piston 712 faster than it escapes through the leaking valve plug 772 where the pressure buildup is limited by the leak (e.g., a calibrated leak), causing the piston 712 to move toward the leaking valve plug 772. Thus, fluidic valves according to the present disclosure may be operated in some configurations by actuating only a single control mechanism (e.g., only one of the valve plugs 772). In additional examples, an external pressure may be leaked in both ends through the fluid inlet 714 and out through opened first and second piston actuation inlets 750 and 752. The pressure may build up on one side of the piston 712 or the other only when the normally open electrosensitive beam 770 closes the respective inlets 750 and 772 with the valve plugs 772, thereby forcing movement of the piston 712. In this case, the state of the fluidic device 700 may otherwise be maintained.

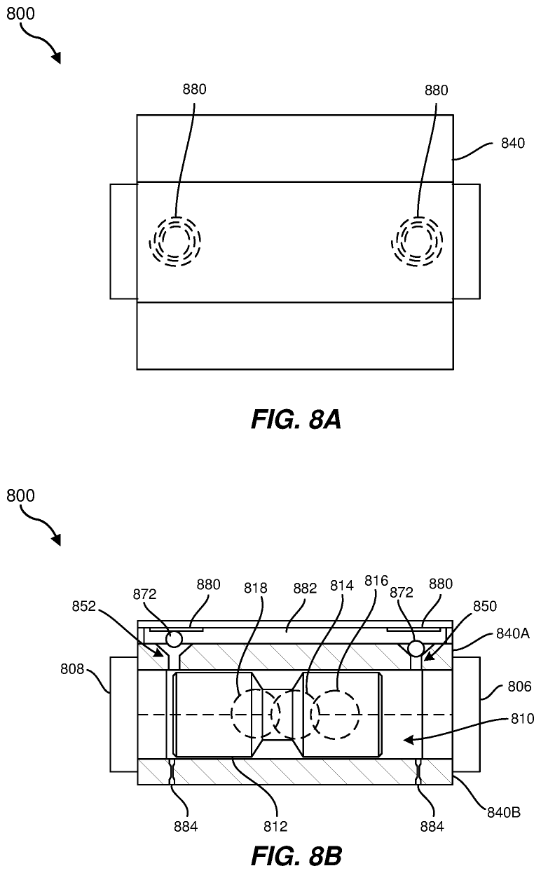

FIGS. 8A and 8B respectively illustrate a top view and a partially transparent, cross-sectional side view of a fluidic device 800, according to at least one additional embodiment of the present disclosure. In some respects, the fluidic device 800 may be similar to the fluidic devices 500, 600, 700 described above. For example, the fluidic device 800 may include a valve body 802, a first endcap 806, and a second endcap 808. A valve chamber 810 may be defined within the valve body 802 and between the endcaps 806, 808. A movable piston 812 may be positioned within the valve chamber 810. Several ports may provide fluid access to the valve chamber 810, such as a fluid inlet 814, a first fluid outlet 816, and a second fluid outlet 818.

The valve body 802 may also include an upper valve housing 840A and a lower valve housing 840B, collectively referred to as a valve housing 840. In some embodiments, the upper valve housing 840A may be substantially identical to the lower valve housing 840B and may be positioned over and secured to the lower valve housing 840B in a face-to-face orientation.

The valve housing 840 may include a first piston actuation inlet 850 and a second piston actuation inlet 852 for fluidically (e.g., pneumatically) controlling the position of the piston 812 within the valve chamber 810. A control fluid (e.g., pressurized air) may be supplied from a control fluid source to opposing sides of the piston 812 through the first and second piston actuation inlets 850, 852. The control fluid may apply pressure to the piston 812 to move the piston 812 between a first position allowing flow between the fluid inlet 814 and the first fluid outlet 816 and a second position allowing flow between the fluid inlet 814 and the second fluid outlet 818. Alternatively or additionally, in some examples, a negative pressure may be applied to the piston 812 through one or both of the first and second piston actuation inlets 850, 852 to move the piston 812 between the first and second positions. Valve plugs 872 may be in position to selectively close and open the first and second piston actuation inlets 850, 852.

In the example shown in FIG. 8, the fluidic device 800 may be electrically controlled, such as with electromagnetic coils 880. In some embodiments, the electromagnetic coils 880 may be driven with field effect transistor current switches. The valve plugs 872 may include a magnetically sensitive material (e.g., a diamagnetic material, a ferromagnetic material, a magnetic material, etc.) that may be sensitive to a magnetic field induced by the electromagnetic coils 880 when activated. Thus, the valve plugs 872 may be selectively moved by the electromagnetic coils 880 between a position closing the first and second piston actuation inlets 850, 852 and a position opening the first and second piston actuation inlets 850, 852. A pressurized control fluid may be present in a chamber 882 in fluid communication with the first and second piston actuation inlets 850, 852. Upon opening the first or second piston actuation inlet 850, 852, the pressurized control fluid may apply a force against the piston 812 to move the piston 812 within the valve chamber 810.

In some embodiments, one or more vent apertures 884 may be in fluid communication with the valve chamber 810. The vent aperture(s) 884 may be configured to vent a portion of the valve chamber 810 that is closed by the respective valve plug 872. This venting may facilitate movement of the piston 812 within the valve chamber 810 and may reduce a magnetic force required to hold the valve plug 872 in a closed position. The vent aperture(s) 884 may be calibrated (e.g., sized and shaped) to supply sufficient leakage and venting while being able to maintain a pressure within the valve chamber 810 to move the piston 812 as may be desired.

Any of the fluidic devices (e.g., fluidic devices 200, 300, 400, 500, 600, 700, 800) described above may be capable of mass production. Various example methods and concepts for mass production are described below with reference to FIGS. 9A-14.

FIGS. 9A-9C illustrate various views of a cylinder blank 900 that may be used in the mass production of fluidic devices, according to at least one embodiment of the present disclosure. FIG. 9A is a perspective view, FIG. 9B is a front side view, and FIG. 9C is a back side view of the cylinder blank 900.

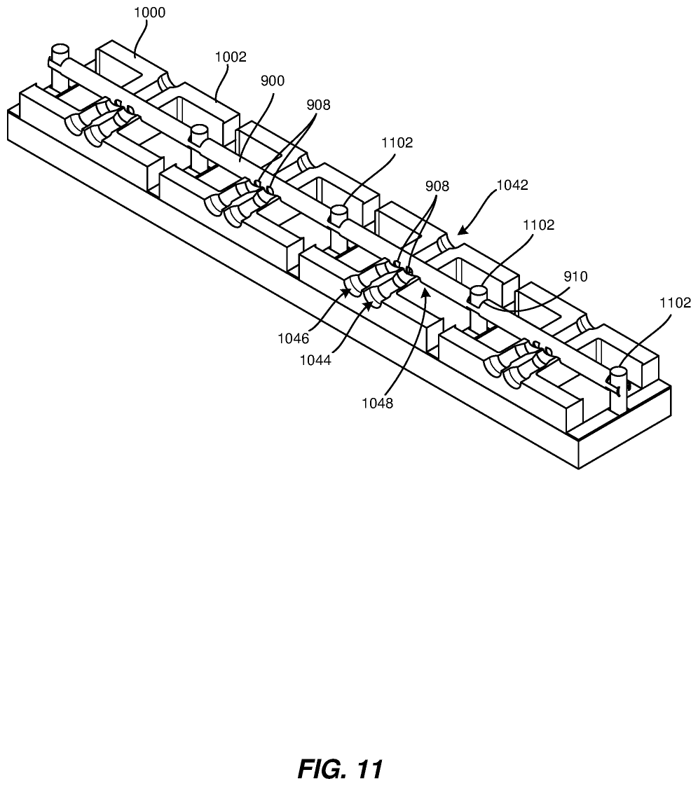

The cylinder blank 900 may include an elongated pipe 902 with several features formed therein to simultaneously produce multiple cylinders for fluidic devices. For example, each section 904 of the cylinder blank 900 may include an inlet port 906 and two outlet ports 908. The sections 904 may be separated by through holes 910 formed in the elongated pipe 902. The through holes 910 may act as dicing apertures to facilitate fabrication and assembly of fluidic devices with the cylinder blank 900, such as by helping the sections 904 to be properly aligned and secured to other components of the fluidic devices to be formed, as will be explained further below with reference to FIG. 11.

Each of the features formed in the cylinder blank 900 (e.g., the inlet ports 906, the outlet ports 908, the through holes 910) may be formed in a variety of ways. For example, these features may be formed by machining (e.g., grinding, laser cutting, waterjet cutting, stamping, etc.).

The cylinder blank 900 may include any number of sections 904 that may be convenient. Four section 904 corresponding to four cylinders for fluidic devices are shown in FIG. 9. However, the present disclosure is not so limited. In additional examples, each cylinder blank 900 may include two, three, four, or more than four sections 904 for forming a corresponding number of cylinders for fluidic devices.

As noted above, the inlet ports 906 may be used as outlet ports of a corresponding fluidic device, and the outlet ports 908 may be used as inlet ports. Thus, the terms “inlet” and “outlet” depend on an intended use of the fluidic device and are used herein for convenience, not by way of limitation.

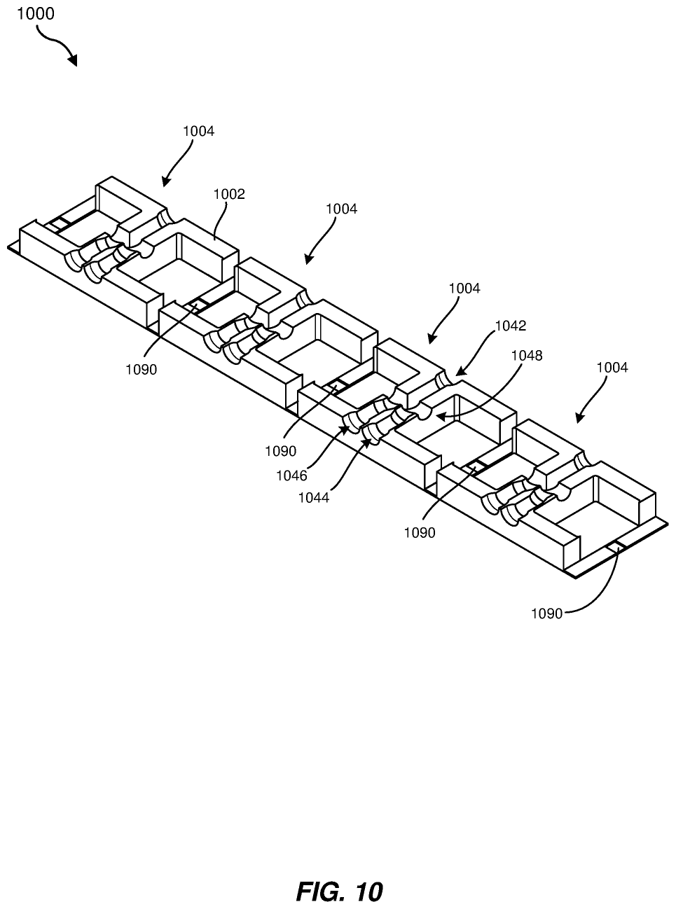

FIG. 10 shows a perspective view of a valve housing blank 1000 that may be used in the mass production of fluidic devices, according to at least one embodiment of the present disclosure. The valve housing blank 1000 may include an elongated base 1002 that has been formed to include features of multiple housings for fluidic devices. For example, the elongated base 1002 may be machined, 3D-printed, molded, or otherwise formed to the valve housing features.

The elongated base 1002 may include multiple sections 1004, each with features for defining a half (e.g., a lower half, an upper half, etc.) of a valve housing. By way of example, each section 1004 illustrated in FIG. 10 may form a housing component similar to or the same as a component of the value housing 640 shown in FIGS. 6A and 6B. However, the present disclosure is not so limited. In additional examples, the elongated base 1002 may be formed to include multiple lower valve housings and/or multiple upper valve housings as illustrated in, for example, FIGS. 5A-5C, 7, 8A, or 8B, or other valve housing designs.

As shown in FIG. 10, each section 1004 of the valve housing blank 1000 may include a valve receptacle 1048 for receiving a cylinder of a fluidic device. Each section 1004 may also include an inlet channel 1042, a first outlet channel 1044, and a second outlet channel 1046. The valve housing blank 1000 may also include a recess 1090 between each section 1004, which may facilitate assembly of fluidic devices, as explained further below with reference to FIG. 11.

FIG. 11 shows a perspective view of the cylinder blank 900 of FIGS. 9A-9C assembled with the housing blank 1000 of FIG. 10 during a mass production process of fluidic devices, according to at least one embodiment of the present disclosure.

As shown in FIG. 11, the cylinder blank 900 may be aligned with and positioned over the housing blank 1000. The cylinder blank 900 may be positioned partially in the valve receptacles 1048 of the housing blank 1000. The outlet ports 908 of the cylinder blank 900 may be aligned with corresponding first and second outlet channels 1044, 1066 of the housing blank 1000, and the inlet ports (not visible from the perspective of FIG. 11) may be aligned with the corresponding inlet channels 1042 of the housing blank 1000.

The cylinder blank 900 may be held in place relative to the housing blank 1000 with pegs 1102, which may pass through and/or be held in the recesses 1090 of the housing blank 1000. The pegs 1102 may also pass through the through holes 910 of the cylinder blank 900, or may be a part of one of the cylinder blank 900 and/or of the housing blank 1000.

In some embodiments, forming the inlet ports 906, outlet ports 908, and through holes 910 in the elongated pipe 902 of the cylinder blank 900 may release inherent mechanical stresses in the elongated pipe 902, such as those that may be induced by extrusion to form the elongated pipe 902. This release of stresses may result in twisting of the cylinder blank 900, which may make it difficult to properly align the features of the cylinder blank 900 with the corresponding features of the housing blank 1000. The pegs 1102 may be used to hold the cylinder blank 900 in an un-twisted state, with the features thereof properly aligned with each other and with the corresponding features of the housing blank 1000.

In some examples, there may be a peg 1102 in each of the through holes 910 of the cylinder blank 900, as illustrated in FIG. 9. In additional embodiments, only some of the through holes 910 may have a peg 1102 therein, with some of the through holes 910 lacking a peg 1102 therein.

After the cylinder blank 900 is properly aligned with the valve housing blank 1000, the cylinder blank 900 may be secured to the valve housing blank 1000, such as with an adhesive, a weld, and/or a fastener.

Another valve housing blank 1000 may be assembled in a face-to-face manner over the cylinder blank 900 and the valve housing blank 1000 shown in FIG. 10. The two valve housing blanks 1000 may be secured to each other, such as via an adhesive, a weld, and/or a fastener. Multiple individual fluidic devices may then be formed by cutting (e.g., dicing) the cylinder blank 900 and valve housing blanks 1000 between each of the sections 904, 1004 (FIGS. 9 and 10) of the cylinder blank 900 and valve housing blanks 1000.

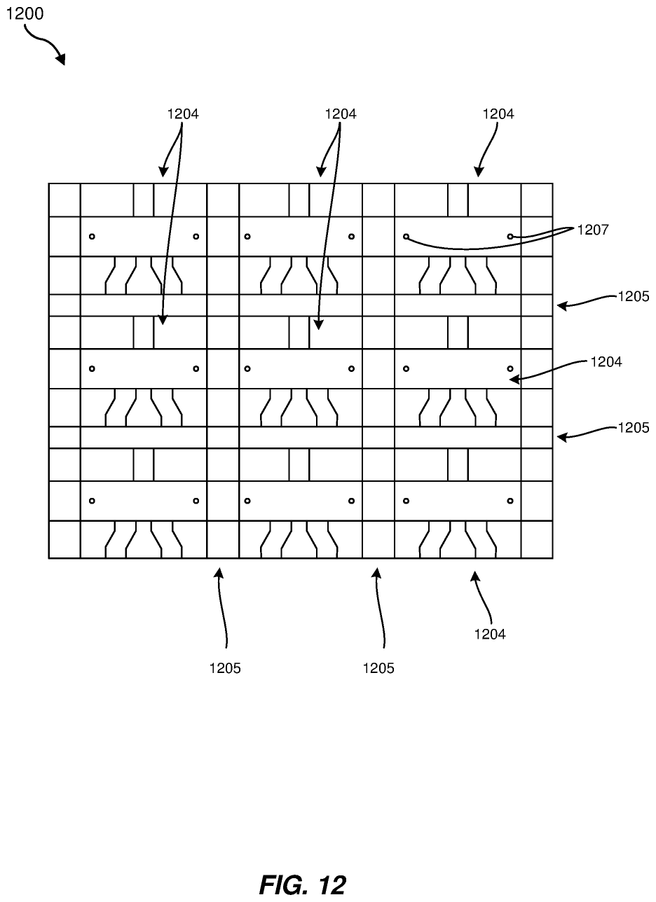

FIG. 12 shows a plan view of a valve housing blank 1200 that may be used in the mass production of fluidic devices, according to at least one additional embodiment of the present disclosure.

In some respects, the valve housing blank 1200 may be similar to the valve housing blank 1000 discussed above with reference to FIG. 10. For example, the valve housing blank 1200 may include multiple sections 1204 including features (e.g., inlet channels, outlet channels, valve receptacles, piston actuation inlets 1207, etc.) for forming multiple valve housings. However, instead of the sections 1204 being arranged in a linear fashion (as the sections 1004 are arranged in FIG. 10), the valve housing blank 1200 of FIG. 12 may include sections 1204 arranged in columns and rows. The sections 1204 may be separated by cut channels 1205 extending in horizontal and vertical directions (e.g., left-and-right and up-and-down from the perspective of FIG. 12).

Assembly of multiple fluidic devices with the valve housing blank 1200 may proceed similar to the process described above with reference to FIG. 11, such as by positioning cylinder blanks 900 within adjacent valve receptacles 1248 of the valve housing blank 1200. The features of the cylinder blanks 900 may be aligned with the corresponding features of the valve housing blank 1200. Another valve housing blank 1200 may be positioned over the cylinder blanks and secured to the valve housing blank 1200 in a face-to-face manner. Multiple individual fluidic devices may then be formed by cutting the assembly along the cut channels 1205.

FIG. 13 is a flow chart showing a method 1300 of forming fluidic devices, according to at least one embodiment of the present disclosure. At operation 1310, a cylinder blank may be formed to include inlet ports and outlet ports. Operation 1310 may be performed in a variety of ways. For example, a pipe may be formed by drawing and/or extrusion, and a sidewall of the pipe may be machined (via, e.g., grinding, laser cutting, waterjet cutting, stamping, etc.) to form the inlet ports and outlet ports. In some examples, the inlet ports may be formed on an opposite side of the pipe from the outlet ports. Additional features may also be formed in the pipe, such as through holes (e.g., through holes 910 of FIG. 9) that may be useful in later assembly procedures.

At operation 1320, a first valve housing blank may be formed to include a portion (e.g., a lower portion) of multiple valve receptacles, inlet channels, and outlet channels. At operation 1330, a second valve housing blank may be formed to include a remaining portion (e.g., an upper portion) of the multiple valve receptacles, inlet channels, and outlet channels. Operations 1320 and 1330 may be performed in a variety of ways. For example, the first and second valve housing blanks may be formed by machining (e.g., grinding, laser cutting, waterjet cutting, stamping, etc.), 3D printing, molding, etc.

At operation 1340, the cylinder blank may be positioned in the valve receptacles of the first valve housing blank. Operation 1340 may be performed in a variety of ways. For example, the inlet ports of the cylinder blank may be aligned with the inlet channels of the first valve housing blank and the outlet ports of the cylinder blank may be aligned with the outlet channels of the first valve housing blank. In some examples, pegs positioned in through holes of the cylinder blank may be used to hold the cylinder blank in the appropriate position and orientation, as described above with reference to FIG. 11. The cylinder blank may be secured to the first valve housing blank, such as with an adhesive, a weld, and/or one or more fasteners, etc.

At operation 1350, a second valve housing may be positioned over the assembled cylinder blank and first valve housing, such as in a face-to-face orientation. Operation 1350 may be performed in a variety of ways. For example, the upper portions of the valve receptacles, inlet channels, and outlet channels in the second valve housing may be aligned with the lower portions of the valve receptacles, inlet channels, and outlet channels in the first valve housing. The second valve housing may be secured to the first valve housing, such as with an adhesive, a weld, and/or one or more fasteners, etc.

Multiple individual fluidic device bodies may then be formed by cutting (e.g., dicing) the assembly. Pistons may be positioned within the respective cylinders, and endcaps may be positioned over ends of the cylinders to hold the pistons inside the cylinders. The endcaps may, in some examples, include a piston actuation inlet therethrough or may lack such an inlet (e.g., if a piston actuation inlet is present through a sidewall of the cylinder). In some embodiments, a first piston actuation inlet and a second piston actuation inlet may be formed to extend into opposing end portions of the cylinders. A first control valve element may be operatively coupled to the first piston actuation inlet and a second control valve element may be operatively coupled to the second piston actuation inlet. For example, the first and second control valve elements may include a magnetic actuator, a piezoelectric actuator, and/or a valve plug.

FIG. 14 is a flow chart showing a method 1400 of forming fluidic devices, according to at least one additional embodiment of the present disclosure. At operation 1410, inlet ports and outlet ports in a sidewall of a cylinder blank may be aligned respectively with inlet channels and outlet channels of a first valve housing blank. The cylinder blank may include inlet ports and outlet ports of multiple fluidic devices. Operation 1410 may be performed in a variety of ways. For example, pegs positioned in through holes of the cylinder blank may be used to hold the cylinder blank in the appropriate position and orientation, as described above with reference to FIG. 11.

At operation 1420, the cylinder blank may be secured to the first valve housing blank. Operation 1420 may be performed in a variety of ways. For example, the cylinder blank may be secured to the first valve housing with an adhesive, a weld, and/or one or more fasteners, etc.

At operation 1430, a second valve housing blank may be positioned over the assembled cylinder blank and first valve housing blank. The second valve housing blank may be placed in a face-to-face orientation relative to the first housing blank. In some examples, the second valve housing blank may be substantially identical (e.g., in shape, size, and features) to the first housing blank. Operation 1430 may be performed in a variety of ways. For example, the upper portions of valve receptacles, inlet channels, and outlet channels in the second valve housing may be aligned with lower portions of the valve receptacles, inlet channels, and outlet channels in the first valve housing.

At operation 1440, the second valve housing may be secured to the first valve housing, such as with an adhesive, a weld, and/or one or more fasteners, etc.

At operation 1450, the assembled cylinder blank, first valve housing, and second valve housing may be cut to form multiple individual fluidic devices. Operation 1450 may be performed in a variety of ways. For example, the assembly may be cut with a rotary blade, a band saw, via laser cutting, via waterjet cutting, etc. The resulting multiple individual valve assemblies may each include one valve receptacle, one cylinder, one inlet channel, one first outlet channel, and one second outlet channel. Each of the valve receptacle, inlet channel, and first and second outlet channels may be defined by portions of the first valve housing and of the second valve housing.

Accordingly, the present disclosure includes fluidic devices and related methods that may provide versatile operation (e.g., operation as a switch and/or as an oscillator, operation as an oscillator at a variety of frequencies, etc.) in a form factor that is scalable, including to a sufficiently small size for practical use in a wearable device (e.g., a haptic glove). In some embodiments, the fluidic devices may be switched (e.g., the piston moving between first and second positions) very quickly, such as in less than 10 milliseconds (e.g., 4-6 milliseconds). As noted above, when configured and operated as a fluidic switch, the fluidic devices may maintain a state without requiring input power. In addition, methods of forming fluidic devices and systems are disclosed, including methods of mass production.

Embodiments of the present disclosure may include or be implemented in conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

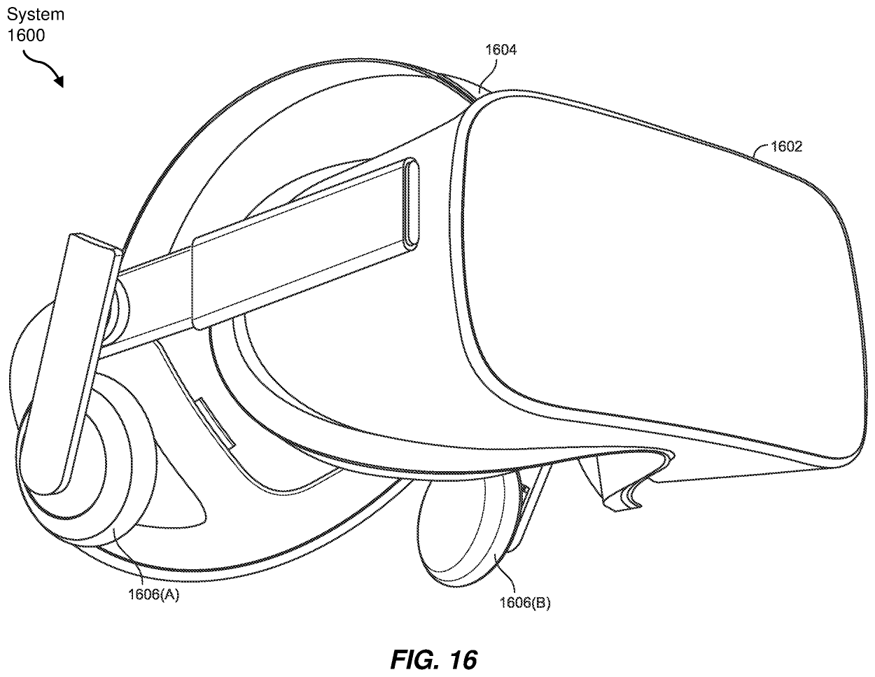

Artificial-reality systems may be implemented in a variety of different form factors and configurations. Some artificial-reality systems may be designed to work without near-eye displays (NEDs). Other artificial-reality systems may include an NED that also provides visibility into the real world (such as, e.g., augmented-reality system 1500 in FIG. 15) or that visually immerses a user in an artificial reality (such as, e.g., virtual-reality system 1600 in FIG. 16). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 15, the augmented-reality system 1500 may include an eyewear device 1502 with a frame 1510 configured to hold a left display device 1515(A) and a right display device 1515(B) in front of a user's eyes. The display devices 1515(A) and 1515(B) may act together or independently to present an image or series of images to a user. While the augmented-reality system 1500 includes two displays, embodiments of this disclosure may be implemented in augmented-reality systems with a single NED or more than two NEDs.

In some embodiments, the augmented-reality system 1500 may include one or more sensors, such as sensor 1540. The sensor 1540 may generate measurement signals in response to motion of the augmented-reality system 1500 and may be located on substantially any portion of the frame 1510. The sensor 1540 may represent one or more of a variety of different sensing mechanisms, such as a position sensor, an inertial measurement unit (IMU), a depth camera assembly, a structured light emitter and/or detector, or any combination thereof. In some embodiments, the augmented-reality system 1500 may or may not include the sensor 1540 or may include more than one sensor. In embodiments in which the sensor 1540 includes an IMU, the IMU may generate calibration data based on measurement signals from the sensor 1540. Examples of the sensor 1540 may include, without limitation, accelerometers, gyroscopes, magnetometers, other suitable types of sensors that detect motion, sensors used for error correction of the IMU, or some combination thereof.

In some examples, the augmented-reality system 1500 may also include a microphone array with a plurality of acoustic transducers 1520(A)-1520(J), referred to collectively as acoustic transducers 1520. The acoustic transducers 1520 may represent transducers that detect air pressure variations induced by sound waves. Each acoustic transducer 1520 may be configured to detect sound and convert the detected sound into an electronic format (e.g., an analog or digital format). The microphone array in FIG. 15 may include, for example, ten acoustic transducers: 1520(A) and 1520(B), which may be designed to be placed inside a corresponding ear of the user, acoustic transducers 1520(C), 1520(D), 1520(E), 1520(F), 1520(G), and 1520(H), which may be positioned at various locations on the frame 1510, and/or acoustic transducers 1520(l) and 1520(J), which may be positioned on a corresponding neckband 1505.

In some embodiments, one or more of the acoustic transducers 1520(A)-(J) may be used as output transducers (e.g., speakers). For example, the acoustic transducers 1520(A) and/or 1520(B) may be earbuds or any other suitable type of headphone or speaker.

The configuration of the acoustic transducers 1520 of the microphone array may vary. While the augmented-reality system 1500 is shown in FIG. 15 as having ten acoustic transducers 1520, the number of acoustic transducers 1520 may be greater or less than ten. In some embodiments, using higher numbers of acoustic transducers 1520 may increase the amount of audio information collected and/or the sensitivity and accuracy of the audio information. In contrast, using a lower number of acoustic transducers 1520 may decrease the computing power required by an associated controller 1550 to process the collected audio information. In addition, the position of each acoustic transducer 1520 of the microphone array may vary. For example, the position of an acoustic transducer 1520 may include a defined position on the user, a defined coordinate on the frame 1510, an orientation associated with each acoustic transducer 1520, or some combination thereof.

The acoustic transducers 1520(A) and 1520(B) may be positioned on different parts of the user's ear, such as behind the pinna, behind the tragus, and/or within the auricle or fossa. Or, there may be additional acoustic transducers 1520 on or surrounding the ear in addition to the acoustic transducers 1520 inside the ear canal. Having an acoustic transducer 1520 positioned next to an ear canal of a user may enable the microphone array to collect information on how sounds arrive at the ear canal. By positioning at least two of the acoustic transducers 1520 on either side of a user's head (e.g., as binaural microphones), the augmented-reality system 1500 may simulate binaural hearing and capture a 3D stereo sound field around about a user's head. In some embodiments, the acoustic transducers 1520(A) and 1520(B) may be connected to the augmented-reality system 1500 via a wired connection 1530, and in other embodiments the acoustic transducers 1520(A) and 1520(B) may be connected to the augmented-reality system 1500 via a wireless connection (e.g., a BLUETOOTH connection). In still other embodiments, the acoustic transducers 1520(A) and 1520(B) may not be used at all in conjunction with the augmented-reality system 1500.

The acoustic transducers 1520 on the frame 1510 may be positioned in a variety of different ways, including along the length of the temples, across the bridge, above or below the display devices 1515(A) and 1515(B), or some combination thereof. The acoustic transducers 1520 may also be oriented such that the microphone array is able to detect sounds in a wide range of directions surrounding the user wearing the augmented reality system 1500. In some embodiments, an optimization process may be performed during manufacturing of the augmented-reality system 1500 to determine relative positioning of each acoustic transducer 1520 in the microphone array.

In some examples, the augmented-reality system 1500 may include or be connected to an external device (e.g., a paired device), such as the neckband 1505. The neckband 1505 generally represents any type or form of paired device. Thus, the following discussion of the neckband 1505 may also apply to various other paired devices, such as charging cases, smart watches, smart phones, wrist bands, other wearable devices, hand-held controllers, tablet computers, laptop computers, other external compute devices, etc.

As shown, the neckband 1505 may be coupled to the eyewear device 1502 via one or more connectors. The connectors may be wired or wireless and may include electrical and/or non-electrical (e.g., structural) components. In some cases, the eyewear device 1502 and neckband 1505 may operate independently without any wired or wireless connection between them. While FIG. 15 illustrates the components of the eyewear device 1502 and neckband 1505 in example locations on the eyewear device 1502 and neckband 1505, the components may be located elsewhere and/or distributed differently on the eyewear device 1502 and/or neckband 1505. In some embodiments, the components of the eyewear device 1502 and neckband 1505 may be located on one or more additional peripheral devices paired with the eyewear device 1502, neckband 1505, or some combination thereof.

Pairing external devices, such as the neckband 1505, with augmented-reality eyewear devices may enable the eyewear devices to achieve the form factor of a pair of glasses while still providing sufficient battery and computation power for expanded capabilities. Some or all of the battery power, computational resources, and/or additional features of the augmented-reality system 1500 may be provided by a paired device or shared between a paired device and an eyewear device, thus reducing the weight, heat profile, and form factor of the eyewear device overall while still retaining desired functionality. For example, the neckband 1505 may allow components that would otherwise be included on an eyewear device to be included in the neckband 1505 since users may tolerate a heavier weight load on their shoulders than they would tolerate on their heads. The neckband 1505 may also have a larger surface area over which to diffuse and disperse heat to the ambient environment. Thus, the neckband 1505 may allow for greater battery and computation capacity than might otherwise have been possible on a stand-alone eyewear device. Since weight carried in the neckband 1505 may be less invasive to a user than weight carried in the eyewear device 1502, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

The neckband 1505 may be communicatively coupled with the eyewear device 1502 and/or to other devices. These other devices may provide certain functions (e.g., tracking, localizing, depth mapping, processing, storage, etc.) to the augmented reality system 1500. In the embodiment of FIG. 15, the neckband 1505 may include two acoustic transducers (e.g., 1520(l) and 1520(J)) that are part of the microphone array (or potentially form their own microphone subarray). The neckband 1505 may also include a controller 1525 and a power source 1535.

The acoustic transducers 1520(l) and 1520(J) of the neckband 1505 may be configured to detect sound and convert the detected sound into an electronic format (analog or digital). In the embodiment of FIG. 15, the acoustic transducers 1520(l) and 1520(J) may be positioned on the neckband 1505, thereby increasing the distance between the neckband acoustic transducers 1520(I) and 1520(J) and the other acoustic transducers 1520 positioned on the eyewear device 1502. In some cases, increasing the distance between the acoustic transducers 1520 of the microphone array may improve the accuracy of beamforming performed via the microphone array. For example, if a sound is detected by the acoustic transducers 1520(C) and 1520(D) and the distance between the acoustic transducers 1520(C) and 1520(D) is greater than, e.g., the distance between the acoustic transducers 1520(D) and 1520(E), the determined source location of the detected sound may be more accurate than if the sound had been detected by the acoustic transducers 1520(D) and 1520(E).

The controller 1525 of the neckband 1505 may process information generated by the sensors on the neckband 1505 and/or the augmented-reality system 1500. For example, the controller 1525 may process information from the microphone array that describes sounds detected by the microphone array. For each detected sound, the controller 1525 may perform a direction-of-arrival (DOA) estimation to estimate a direction from which the detected sound arrived at the microphone array. As the microphone array detects sounds, the controller 1525 may populate an audio data set with the information. In embodiments in which the augmented-reality system 1500 includes an inertial measurement unit, the controller 1525 may compute all inertial and spatial calculations from the IMU located on the eyewear device 1502. A connector may convey information between the augmented-reality system 1500 and the neckband 1505 and between the augmented-reality system 1500 and the controller 1525. The information may be in the form of optical data, electrical data, wireless data, or any other transmittable data form. Moving the processing of information generated by the augmented-reality system 1500 to the neckband 1505 may reduce weight and heat in the eyewear device 1502, making it more comfortable for the user.

The power source 1535 in the neckband 1505 may provide power to the eyewear device 1502 and/or to the neckband 1505. The power source 1535 may include, without limitation, lithium-ion batteries, lithium-polymer batteries, primary lithium batteries, alkaline batteries, or any other form of power storage. In some cases, the power source 1535 may be a wired power source. Including the power source 1535 on the neckband 1505 instead of on the eyewear device 1502 may help better distribute the weight and heat generated by the power source 1535.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 1600 in FIG. 16, that mostly or completely covers a user's field of view. The virtual-reality system 1600 may include a front rigid body 1602 and a band 1604 shaped to fit around a user's head. The virtual-reality system 1600 may also include output audio transducers 1606(A) and 1606(B). Furthermore, while not shown in FIG. 16, the front rigid body 1602 may include one or more electronic elements, including one or more electronic displays, one or more inertial measurement units (IMUs), one or more tracking emitters or detectors, and/or any other suitable device or system for creating an artificial-reality experience.

Artificial-reality systems may include a variety of types of visual feedback mechanisms. For example, display devices in the augmented-reality system 1500 and/or the virtual-reality system 1600 may include one or more liquid crystal displays (LCDs), light emitting diode (LED) displays, microLED displays, organic LED (OLED) displays, digital light projector (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., conventional concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in the augmented reality system 1500 and/or virtual-reality system 1600 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, the augmented-reality system 1500 and/or virtual-reality system 1600 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, bodysuits, handheld controllers, environmental devices (e.g., chairs, floor mats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

As noted, the augmented-reality system 1500 and virtual-reality system 1600 may be used with a variety of other types of devices to provide a more compelling artificial-reality experience. These devices may be haptic interfaces with transducers that provide haptic feedback and/or that collect haptic information about a user's interaction with an environment. The artificial-reality systems disclosed herein may include various types of haptic interfaces that detect or convey various types of haptic information, including tactile feedback (e.g., feedback that a user detects via nerves in the skin, which may also be referred to as cutaneous feedback) and/or kinesthetic feedback (e.g., feedback that a user detects via receptors located in muscles, joints, and/or tendons).

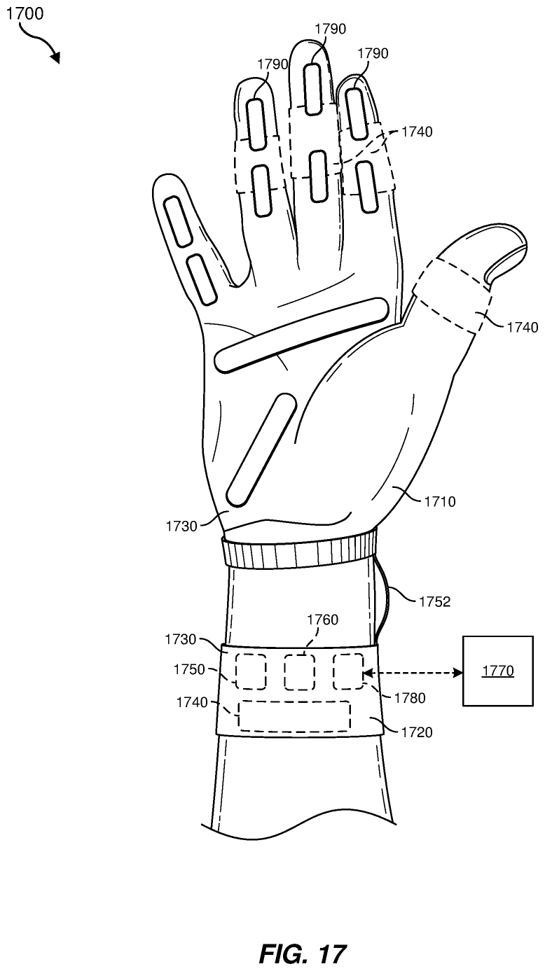

Haptic feedback may be provided by interfaces positioned within a user's environment (e.g., chairs, tables, floors, etc.) and/or interfaces on articles that may be worn or carried by a user (e.g., gloves, wristbands, etc.). As an example, FIG. 17 illustrates a vibrotactile system 1700 in the form of a wearable glove (haptic device 1710) and wristband (haptic device 1720). The haptic device 1710 and the haptic device 1720 are shown as examples of wearable devices that include a flexible, wearable textile material 1730 that is shaped and configured for positioning against a user's hand and wrist, respectively. This disclosure also includes vibrotactile systems that may be shaped and configured for positioning against other human body parts, such as a finger, an arm, a head, a torso, a foot, or a leg. By way of example and not limitation, vibrotactile systems according to various embodiments of the present disclosure may also be in the form of a glove, a headband, an armband, a sleeve, a head covering, a sock, a shirt, or pants, among other possibilities. In some examples, the term “textile” may include any flexible, wearable material, including woven fabric, non-woven fabric, leather, cloth, a flexible polymer material, composite materials, etc.

One or more vibrotactile devices 1740 may be positioned at least partially within one or more corresponding pockets formed in the textile material 1730 of the vibrotactile system 1700. The vibrotactile devices 1740 may be positioned in locations to provide a vibrating sensation (e.g., haptic feedback) to a user of the vibrotactile system 1700. For example, the vibrotactile devices 1740 may be positioned against the user's finger(s), thumb, or wrist, as shown in FIG. 17. The vibrotactile devices 1740 may, in some examples, be sufficiently flexible to conform to or bend with the user's corresponding body part(s).

A power source 1750(e.g., a battery) for applying a voltage to the vibrotactile devices 1740 for activation thereof may be electrically coupled to the vibrotactile devices 1740, such as via conductive wiring 1752. In some examples, each of the vibrotactile devices 1740 may be independently electrically coupled to the power source 1750 for individual activation. In some embodiments, a processor 1760 may be operatively coupled to the power source 1750 and configured (e.g., programmed) to control activation of the vibrotactile devices 1740.

The vibrotactile system 1700 may be implemented in a variety of ways. In some examples, the vibrotactile system 1700 may be a standalone system with integral subsystems and components for operation independent of other devices and systems. As another example, the vibrotactile system 1700 may be configured for interaction with another device or system 1770. For example, the vibrotactile system 1700 may, in some examples, include a communications interface 1780 for receiving and/or sending signals to the other device or system 1770. The other device or system 1770 may be a mobile device, a gaming console, an artificial-reality (e.g., virtual-reality, augmented-reality, mixed-reality) device, a personal computer, a tablet computer, a network device (e.g., a modem, a router, etc.), a handheld controller, etc. The communications interface 1780 may enable communications between the vibrotactile system 1700 and the other device or system 1770 via a wireless (e.g., Wi-Fi, BLUETOOTH, cellular, radio, etc.) link or a wired link. If present, the communications interface 1780 may be in communication with the processor 1760, such as to provide a signal to the processor 1760 to activate or deactivate one or more of the vibrotactile devices 1740.

The vibrotactile system 1700 may optionally include other subsystems and components, such as touch-sensitive pads 1790, pressure sensors, motion sensors, position sensors, lighting elements, and/or user interface elements (e.g., an on/off button, a vibration control element, etc.). During use, the vibrotactile devices 1740 may be configured to be activated for a variety of different reasons, such as in response to the user's interaction with user interface elements, a signal from the motion or position sensors, a signal from the touch-sensitive pads 1790, a signal from the pressure sensors, a signal from the other device or system 1770, etc.

Although the power source 1750, processor 1760, and communications interface 1780 are illustrated in FIG. 17 as being positioned in the haptic device 1720, the present disclosure is not so limited. For example, one or more of the power source 1750, processor 1760, or communications interface 1780 may be positioned within the haptic device 1710 or within another wearable textile.

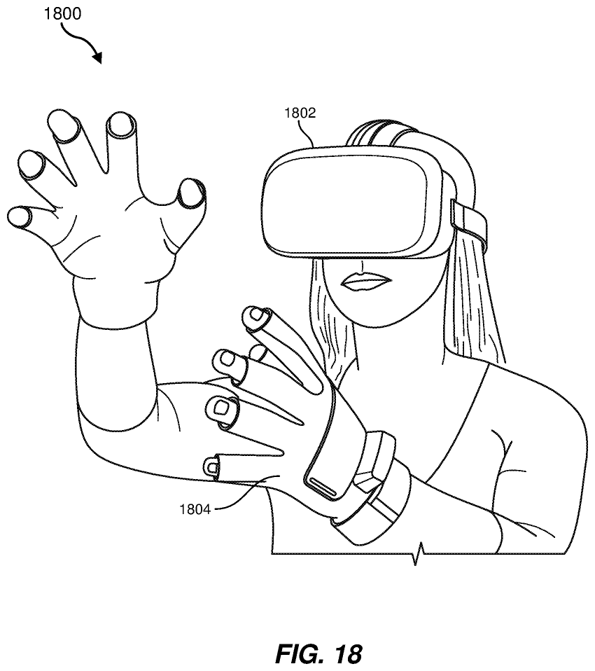

Haptic wearables, such as those shown in and described in connection with FIG. 17, may be implemented in a variety of types of artificial-reality systems and environments. FIG. 18 shows an example artificial-reality environment 1800 including one head-mounted virtual-reality display and two haptic devices (e.g., gloves), and in other embodiments any number and/or combination of these components and other components may be included in an artificial-reality system. For example, in some embodiments there may be multiple head-mounted displays each having an associated haptic device, with each head-mounted display and each haptic device communicating with the same console, portable computing device, or other computing system.

The head-mounted display 1802 generally represents any type or form of virtual-reality system, such as the virtual-reality system 1600 in FIG. 16. A haptic device 1804 generally represents any type or form of wearable device, worn by a user of an artificial-reality system, that provides haptic feedback to the user to give the user the perception that he or she is physically engaging with a virtual object. In some embodiments, the haptic device 1804 may provide haptic feedback by applying vibration, motion, and/or force to the user. For example, the haptic device 1804 may limit or augment a user's movement. To give a specific example, the haptic device 1804 may limit a user's hand from moving forward so that the user has the perception that his or her hand has come in physical contact with a virtual wall. In this specific example, one or more actuators within the haptic device may achieve the physical-movement restriction by pumping fluid into an inflatable bladder of the haptic device. In some examples, a user may also use the haptic device 1804 to send action requests to a console. Examples of action requests include, without limitation, requests to start an application and/or end the application and/or requests to perform a particular action within the application.

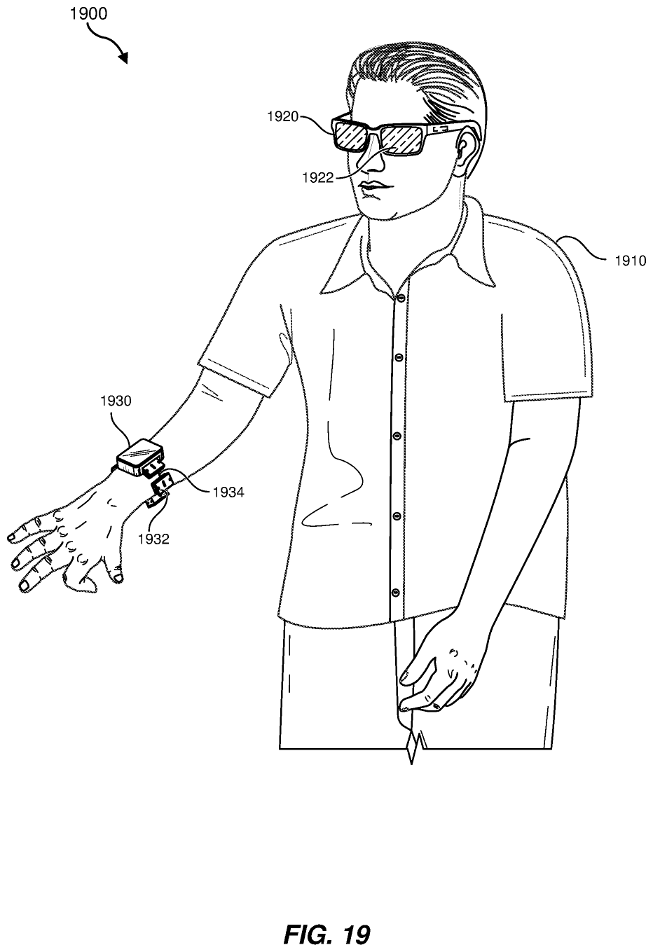

While haptic interfaces may be used with virtual-reality systems, as shown in FIG. 18, haptic interfaces may also be used with augmented-reality systems, as shown in FIG. 19. FIG. 19 is a perspective view of a user 1910 interacting with an augmented-reality system 1900. In this example, the user 1910 may wear a pair of augmented-reality glasses 1920 that may have one or more displays 1922 and that are paired with a haptic device 1930. In this example, the haptic device 1930 may be a wristband that includes a plurality of band elements 1932 and a tensioning mechanism 1934 that connects the band elements 1932 to one another.

One or more of the band elements 1932 may include any type or form of actuator suitable for providing haptic feedback. For example, one or more of the band elements 1932 may be configured to provide one or more of various types of cutaneous feedback, including vibration, force, traction, texture, and/or temperature. To provide such feedback, the band elements 1932 may include one or more of various types of actuators. In one example, each of the band elements 1932 may include a vibrotactor (e.g., a vibrotactile actuator) configured to vibrate in unison or independently to provide one or more of various types of haptic sensations to a user. Alternatively, only a single band element or a subset of band elements may include vibrotactors.

The haptic devices 1710, 1720, 1804, and 1930 may include any suitable number and/or type of haptic transducer, sensor, and/or feedback mechanism. For example, the haptic devices 1710, 1720, 1804, and 1930 may include one or more mechanical transducers, piezoelectric transducers, and/or fluidic transducers. The haptic devices 1710, 1720, 1804, and 1930 may also include various combinations of different types and forms of transducers that work together or independently to enhance a user's artificial-reality experience. In one example, each of the band elements 1932 of the haptic device 1930 may include a vibrotactor (e.g., a vibrotactile actuator) configured to vibrate in unison or independently to provide one or more of various types of haptic sensations to a user.

The following example embodiments are also included in the present disclosure:

Example 1: A fluidic device, which may include: a valve body including an upper valve housing and a lower valve housing secured to each other; a cylinder positioned between the upper valve housing and the lower valve housing, wherein the cylinder includes: a valve chamber within the cylinder; a fluid inlet port extending through a sidewall of the cylinder and in fluid communication with the valve chamber; and a first fluid outlet port and a second fluid outlet port extending through the sidewall of the cylinder opposite the fluid inlet port, the first fluid outlet port and the second fluid outlet port in fluid communication with the valve chamber; and a piston positioned within the valve chamber, the piston movable between a first position allowing flow from the fluid inlet port to the first fluid outlet port and a second position allowing flow from the fluid inlet port to the second fluid outlet port.

Example 2: The fluidic device of Example 1, further including: a first piston actuation inlet extending into a first end portion of the cylinder, wherein introduction of a pressurized control fluid into the valve chamber through the first piston actuation inlet moves the piston from the first position to the second position; and a second piston actuation inlet extending into a second, opposite end portion of the cylinder, wherein introduction of the pressurized control fluid into the valve chamber through the second piston actuation inlet moves the piston from the second position to the first position.

Example 3: The fluidic device of Example 2, further including: a first valve plug configured to selectively close and open the first piston actuation inlet; and a second valve plug configured to selectively close and open the second piston actuation inlet.

Example 4: The fluidic device of Example 3, wherein the first valve plug and the second valve plug are controlled by at least one of: a piezoelectric actuator; or an electromagnetic actuator.

Example 5: The fluidic device of any of Examples 1 through 4, wherein the fluidic device is configured to maintain flow into the first fluid outlet or the second fluid outlet when no energy is supplied to the fluidic device.

Example 6: The fluidic device of any one of Examples 1 through 5, wherein the piston at least substantially blocks the first fluid outlet when the piston is in the second position and at least substantially blocks the second fluid outlet when the piston is in the first position.

Example 7: The fluidic device of any one of Examples 1 through 6, wherein an internal diameter of the fluid inlet is about 2 mm or less.

Example 8: The fluidic device of any one of Examples 1 through 7, wherein the piston has an enlarged first end portion, an enlarged second end portion opposite the first end portion, and a central shaft between the enlarged first end portion and the enlarged second end portion, wherein the central shaft has a smaller diameter than the first and second end portions.

Example 9: A method of forming fluidic devices, which method may include: forming a cylinder blank, including: forming inlet ports in a sidewall of a pipe; and forming outlet ports in the sidewall of the pipe opposite from the inlet ports; forming a first valve housing blank including a portion of multiple valve receptacles, inlet channels, and outlet channels; forming a second valve housing blank including a remaining portion of the multiple valve receptacles, inlet channels, and outlet channels; positioning the cylinder blank in the valve receptacles of the first valve housing blank; and positioning the second valve housing blank over the assembled cylinder blank and first valve housing blank.

Example 10: The method of Example 9, further including securing the second valve housing blank to the first valve housing blank.

Example 11: The method of Example 10, wherein securing the second valve housing blank to the first valve housing blank includes at least one of adhering, welding, or fastening the second valve housing blank to the first valve housing blank.

Example 12: The method of any one of Examples 9 through 11, further including dicing the assembled first valve housing blank and second valve housing blank into valve assemblies each including one valve receptacle, one cylinder, one inlet channel, one first outlet channel, and one second outlet channel.

Example 13: The method of Example 12, further including positioning two endcaps to respectively cover opposing ends of each cylinder.

Example 14: The method of any one of Examples 9 through 13, further including positioning a piston within each cylinder.

Example 15: The method of Example 14, further including: forming a first piston actuation inlet extending into each of the cylinders at a first end portion of the cylinders; and forming a second piston actuation inlet extending into each of the cylinders at a second, opposite end portion of the cylinders.

Example 16: The method of Example 15, further including coupling a first control valve element to the first piston actuation inlet and coupling a second control valve element to the second piston actuation inlet, wherein the first control valve element and the second control valve element are operable to move the piston within the cylinder between a first and a second position, wherein the piston in the first position allows fluid flow between the inlet port and the first outlet port and the piston in the second position allows fluid flow between the inlet port and the second outlet port.

Example 17: The method of any one of Examples 9 through 16, further including cutting the pipe into a plurality of cylinders each including one of the inlet ports and two of the outlet ports.

Example 18: The method of Example 17, wherein the cutting of the pipe into the plurality of the cylinders is performed after positioning the cylinder blank in the valve receptacles of the first valve housing blank and after positioning the second valve housing blank over the assembled cylinder blank and first valve housing blank.

Example 19: A method of forming fluidic devices, which method may include: aligning inlet ports and outlet ports in a sidewall of a cylinder blank with, respectively, inlet channels and outlet channels of a first valve housing blank; securing the cylinder blank to the first valve housing blank; positioning a second valve housing blank over the cylinder blank and the first valve housing blank in a face-to-face configuration with the first valve housing blank; securing the second valve housing blank to the first valve housing blank; and cutting the assembled cylinder blank, first valve housing blank, and second valve housing blank to form multiple individual fluidic devices each including a cylinder between a first valve housing and a second valve housing.

Example 20: The method of Example 19, further including positioning a piston within each cylinder of the multiple individual fluidic devices, the piston shaped and sized for selectively allowing fluid flow between the inlet port and one outlet port at a time depending on a position of the piston within the cylinder.

Example 21: A fluidic device, which may include: a valve chamber in a valve body; a fluid inlet in fluid communication with the valve chamber; a movable piston positioned within the valve chamber, wherein the piston includes at least one of a diamagnetic material, a ferromagnetic material, or a magnetic material; a first fluid outlet for passing fluid out of the valve chamber when the piston is in a first position; a second fluid outlet for passing fluid out of the valve chamber when the piston is in a second position; and at least one magnetic drive mechanism configured to apply a magnetic field to move the piston between the first and second positions.

Example 22: The fluidic device of Example 21, wherein the at least one magnetic drive mechanism includes at least one conductive coil wrapped around the valve chamber.

Example 23: The fluidic device of Example 22, wherein the at least one conductive coil includes a first conductive coil wrapped around a first side of the valve chamber and a second conductive coil wrapped around a second side of the valve chamber.

Example 24: The fluidic device of any of Examples 21 through 23, wherein the fluidic device is configured to maintain flow into the first fluid outlet or the second fluid outlet when no magnetic field is applied by the at least one magnetic drive mechanism.

Example 25: The fluidic device of any of Examples 21 through 24, wherein the piston at least substantially blocks the first fluid outlet when the piston is in the second position and at least substantially blocks the second fluid outlet when the piston is in the first position.

Example 26: The fluidic device of any of Examples 21 through 25, wherein an internal diameter of the fluid inlet is about 2 mm or less.

Example 27: The fluidic device of any of Examples 21 through 26, wherein the piston has an enlarged first end portion, an enlarged second end portion opposite the first end portion, and a central shaft between the enlarged first end portion and the enlarged second end portion, wherein the central shaft has a smaller diameter than the first and second end portions.

Example 28: The fluidic device of any of Examples 21 through 27, wherein the valve body includes an upper valve body and a lower valve body secured to each other.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

The preceding description has been provided to enable others skilled in the art to best utilize various aspects of the example embodiments disclosed herein. This example description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

The invention claimed is:

1. A fluidic device, comprising:
a valve body including an upper valve housing and a lower valve housing secured to each other;
a cylinder positioned between the upper valve housing and the lower valve housing, wherein the cylinder comprises:
a valve chamber within the cylinder;
a fluid inlet port extending through a sidewall of the cylinder and in fluid communication with the valve chamber; and
a first fluid outlet port and a second fluid outlet port extending through the sidewall of the cylinder opposite the fluid inlet port, the first fluid outlet port and the second fluid outlet port in fluid communication with the valve chamber; and
a piston positioned within the valve chamber, the piston movable between a first position allowing flow from the fluid inlet port to the first fluid outlet port and a second position allowing flow from the fluid inlet port to the second fluid outlet port.

2. The fluidic device of claim 1, further comprising:
a first piston actuation inlet extending into a first end portion of the cylinder, wherein introduction of a pressurized control fluid into the valve chamber through the first piston actuation inlet moves the piston from the first position to the second position; and
a second piston actuation inlet extending into a second, opposite end portion of the cylinder, wherein introduction of the pressurized control fluid into the valve chamber through the second piston actuation inlet moves the piston from the second position to the first position.

3. The fluidic device of claim 2, further comprising:
a first valve plug configured to selectively close and open the first piston actuation inlet; and
a second valve plug configured to selectively close and open the second piston actuation inlet.

4. The fluidic device of claim 3, wherein the first valve plug and the second valve plug are controlled by at least one of:
a piezoelectric actuator; or
an electromagnetic actuator.

5. The fluidic device of claim 1, wherein the fluidic device is configured to maintain flow into the first fluid outlet or the second fluid outlet when no energy is supplied to the fluidic device.

6. The fluidic device of claim 1, wherein the piston at least substantially blocks the first fluid outlet when the piston is in the second position and at least substantially blocks the second fluid outlet when the piston is in the first position.

7. The fluidic device of claim 1, wherein an internal diameter of the fluid inlet is about 2 mm or less.

8. The fluidic device of claim 1, wherein the piston has an enlarged first end portion, an enlarged second end portion opposite the first end portion, and a central shaft between the enlarged first end portion and the enlarged second end portion, wherein the central shaft has a smaller diameter than the first and second end portions.

9. A method of forming fluidic devices, the method comprising:
forming a cylinder blank, comprising:
forming inlet ports in a sidewall of a pipe; and
forming outlet ports in the sidewall of the pipe opposite from the inlet ports;
forming a first valve housing blank including a portion of multiple valve receptacles, inlet channels, and outlet channels;
forming a second valve housing blank including a remaining portion of the multiple valve receptacles, inlet channels, and outlet channels;
positioning the cylinder blank in the valve receptacles of the first valve housing blank; and
positioning the second valve housing blank over the assembled cylinder blank and first valve housing blank.

10. The method of claim 9, further comprising securing the second valve housing blank to the first valve housing blank.

11. The method of claim 10, wherein securing the second valve housing blank to the first valve housing blank comprises at least one of adhering, welding, or fastening the second valve housing blank to the first valve housing blank.

12. The method of claim 9, further comprising dicing the assembled first valve housing blank and second valve housing blank into valve assemblies each including one valve receptacle, one cylinder, one inlet channel, one first outlet channel, and one second outlet channel.

13. The method of claim 12, further comprising positioning two endcaps to respectively cover opposing ends of each cylinder.

14. The method of claim 9, further comprising positioning a piston within each cylinder.

15. The method of claim 14, further comprising:
forming a first piston actuation inlet extending into each of the cylinders at a first end portion of the cylinders; and
forming a second piston actuation inlet extending into each of the cylinders at a second, opposite end portion of the cylinders.

16. The method of claim 15, further comprising coupling a first control valve element to the first piston actuation inlet and coupling a second control valve element to the second piston actuation inlet, wherein the first control valve element and the second control valve element are operable to move the piston within the cylinder between a first and a second position, wherein the piston in the first position allows fluid flow between the inlet channel and the first outlet channel and the piston in the second position allows fluid flow between the inlet channel and the second outlet channel.

17. The method of claim 9, further comprising cutting the pipe into a plurality of cylinders each including one of the inlet ports and two of the outlet ports.

18. The method of claim 17, wherein the cutting of the pipe into the plurality of the cylinders is performed after positioning the cylinder blank in the valve receptacles of the first valve housing blank and after positioning the second valve housing blank over the assembled cylinder blank and first valve housing blank.

19. A method of forming fluidic devices, the method comprising:
aligning inlet ports and outlet ports in a sidewall of a cylinder blank with, respectively, inlet channels and outlet channels of a first valve housing blank;
securing the cylinder blank to the first valve housing blank;
positioning a second valve housing blank over the cylinder blank and the first valve housing blank in a face-to-face configuration with the first valve housing blank;
securing the second valve housing blank to the first valve housing blank; and
cutting the assembled cylinder blank, first valve housing blank, and second valve housing blank to form multiple individual fluidic devices each including a cylinder between a first valve housing and a second valve housing.

20. The method of claim 19, further comprising positioning a piston within each cylinder of the multiple individual fluidic devices, the piston shaped and sized for selectively allowing fluid flow between the inlet port and one outlet port at a time depending on a position of the piston within the cylinder.
